(19) United States
(12) Patent Application Publication
(10) Pub. No.: US 2011/0296291 A1
(43) Pub. Date: Dec. 1, 2011

(54) SYSTEM AND METHOD FOR TRANSFORMING DOCUMENTS FOR PUBLISHING ELECTRONICALLY

(76) Inventors: Olya Melkinov, New South Wales (AU); Justin Stenning, Victoria (AU); Aaron Everingham, New South Wales (AU)

(21) Appl. No.: 12/743,072

(22) PCT Filed: Nov. 14, 2008
(86) PCT No.: PCT/AU08/01693

§ 371 Date: Aug. 23, 2010

(30) Foreign Application Priority Data
Nov. 15, 2007 (AU) 2007906285

(51) Int. Cl. G06F 17/21; G06F 17/24

(52) U.S. Cl. 715/229; 715/243; 715/235

(57) ABSTRACT

The invention of the present invention is directed to a rules based engine for taking large numbers of documents and publishing them electronically using a rules based segmentation, linking and versioning engine. The invention is primarily concerned with the ability of the system to perform the following steps. Receive a document (10), receive segmentation rules (20), run segmentation rules (30), display possible segments based on metadata extracted from the running of the rules (30) and if acceptable segmentation points are identified, created logical segments (50), assign one or more unique identifiers (60) and receive (70) and run (80) linking rules, creating actual segmented documents with potential link points identified (100) and reducing potential link points to actual links (110) wherein the documents are therein ready to be published. The invention is further directed to a system that is capable of republishing amended documents such that the republished segments are assigned the same address and thereby facilitating third party persistent linking. The versioning and comparison engine is also adapted to provide a collaborative environment where many people can author individual segments of a single document in a collaborative online environment.

### FIELD OF THE INVENTION

The field of the present invention is electronic publishing. In particular, the invention relates to a novel method of publishing large volumes of unstructured data, and methods for updating, amending, and/or re-organising already published unstructured data.

### BACKGROUND TO THE INVENTION

Organisations, including government organisations, publish millions of documents online every year.

The difficulty in managing the online publication (including generation of millions of links to other documents) and the process of updating these publications and links is a significant problem for maintaining up-to-date electronic repositories of published documents.

Publishing documents electronically in a manner that facilitates updates to the documents is hampered by the fact that many organisations find that their files reside in different repositories and in different file formats with inconsistencies in style, formatting, structure and the quality of the meta data surrounding content.

The different repositories may include Electronic Data Management Systems (EDMS), Content Management Systems (CMS), file systems, local drives, or web sites. The different file formats may include Word, Excel, PDF, HTML, XML, PowerPoint, text, or RTF.

There are no existing technologies which can take these diverse file formats and transform their content into a single document database from which the publication to a variety of different outputs can occur.

Whilst there are many CMSs on the market that can manage large volumes of data, the data needs to be entered manually in order for the user to take advantage of the power of electronic document CMS.

When prior art systems are faced with updated documents, the painstaking task of entering the data into the CMS needs to be repeated before updating the website.

Existing tools and CMSs are unable to preserve the links between electronic documents, and further, preserve external links to existing documents or portions of documents, particularly if the portions of documents are moved within a document.

In the context of publishing legislation, there is a need for a system for quickly transforming the diverse sources of content for inclusion in a document database which is then exported for use in a compatible CMS, and which is subsequently also able to be used for adding, deleting, and modifying only the content of interest in a manner that is efficient and avoids the need to republish the whole of the content.

There is also a need for system for assisting people to collaboratively author documents. Presently collaboration software is deficient. Such software usually incorporates a shared workspace which is able to be accessed online. It may have certain security and permissions associated with providing access. Generally in such systems collaboration partners upload documents, primarily word documents that to this workspace where they can checked out by authorised participants. If one person has checked out the document, it is locked for editing until that person checks it back in or passes it to the next person in an approval process. Only one person can work on a document at any given time, unless it is copied in which case version management becomes a problem. At all times, any editing is done in the desktop format. Revision tracking is as per MS-Word. It is difficult to keep an audit trail with multiple changes being made and when some changes are accepted and other s are not. Linking is problematic, particularly as a single workflow is used. All documents must be consumed in their entirety. One cannot split the document. There can be only one workflow per document. This means that Financial people are handling the same document as Marketing and technical people. This is inefficient and there exists a need to improve such software.

It is therefore an object of the invention to provide a substantially automated method for publishing large volumes of documents electronically that is capable of addressing the problems and needs of the prior art.

### SUMMARY OF THE INVENTION

According to a first aspect of the present invention there is provided a method for dynamically publishing documents electronically, the method comprising the following steps:
Receiving at least one segmentation rule;
running the at least one segmentation rule;
displaying the potential segmentation points;
receiving input as to the acceptability of the potential segmentation points identified;
iteratively repeating the steps of receiving at least one segmentation rule and running over the at least one document and displaying the identified potential segmentation points until such time that the displayed identified potential segmentation points have been indicated to be acceptable by reference to received input;
segmenting the document;
associating at least one unique identifier with each segment along with metadata that was used to identify and display the acceptable potential segmentations points with their associated logical segment;
receiving a linking rule;
running a linking rule to create potential link targets in the content of the segments;
displaying the potential links;
iteratively repeating the steps of running the at least one linking rule over each segment and reporting the collection of potential links until such time that the collection of potential links have been indicated to be acceptable by reference to received input;
resolving actual links from the list of generated potential links;
publishing the segments electronically with actual links;

According to a second aspect of the present invention there is provided a method for dynamically publishing documents electronically, wherein the segmentation and linking rules are able to identify metadata in the at least one document's structure by reference to any one or more of the following:
formatting including levels of indentation and numbering
available styles
content
predefined definitions
hidden text
embedded links; and
any other segment identifier

Preferably, the step of segmenting the document involves first segmenting the document into logical segments, and wherein the document is not divided into separate documents or actual segments until after the linking rule has been run over the at least one document to insert the potential links.

More preferably, the potential links are stored as mark up text, containing at least one unique identifier in the logical segments that comprises a link target.

It is preferred that the step of resolving actual links from potential links involves a correlating the at least one unique identifier contained in the markup associated with the potential link of an actual segment with the unique identifiers of the actual segments to be published and where there is correlation, creating an actual link between the actual segments.

In a preferred embodiment after the at least one document is received its structure is analysed and one or more suggested segmentation rules are suggested to the user before the user provides an indication as to which rule to run over the at least one document.

Preferably, the logical segments are associated with two unique identifiers.

More preferably, the two unique identifiers are the GUID and PageLinkRef.

It is preferred that the actual segments are stored in a store by reference to their two unique identifiers.

In a preferred embodiment, the contents of the store when published, are published as HTML files.

Preferably, the at least one unique identifier is associated with the filename and hence URL of the published HTML files.

More preferably, the contents of the store are published by a content management system.

It is preferred that the content management system associates the address of the published document with at least one of the two unique identifiers.

In a preferred embodiment, the at least one unique identifier is the GUID.

Preferably, the at least one document is further subjected to the application of one or more of the following prior to publication:
cleaning rules,
substitution rules.
accessibility and compliance rules.

According to a third aspect of the prevention there is provided a method for dynamically publishing documents electronically wherein the following extra steps are conducted in order to publish amended version of documents previously published in accordance with the method, the extra steps comprising,
receiving at least one amended document for republishing
performing the segmentation and linking in order to create actual segmented and linked documents
correlating the previously segmented and published documents with the newly segmented documents and in the case where there is a correlation, assigning the at least one unique identifier of the previously published document to the newly created actual document that correlated with that previously published document, and in the case where no correlation with a previously published document can be found, assigning the uncorrelated document a new at least one unique identifier
publishing the documents, wherein the file names, address and/or location of each physical segment of the updated document remains unchanged from the address and/or location of the previously published document which it replaced.

According to a fourth aspect of the invention there is provided a method for dynamically publishing documents electronically, the method comprising the following steps:
receiving at least one segmentation rule for identifying metadata in at least one document's structure by reference to one or more of the following
   i. formatting including levels of indentation and numbering
   ii. available styles
   iii. content
   iv. predefined definitions
   v. hidden text
   vi. embedded links;
running the at least one segmentation rule over the at least one document to identify metadata for identifying and displaying potential segmentation points;
iteratively repeating the steps of receiving at least one segmentation rule and running over the at least one document and displaying the identified potential segmentation points until such time that the displayed identified potential segmentation points have been indicated to be acceptable by reference to received input;
segmenting the at least one document into logical segments
associating at least one unique identifier along with the metadata that was used to display the acceptable potential segmentations points with their associated logical segment;
receiving at least one linking rule for identifying potential links between the logical segments identified by their at least one unique identifier wherein the linking rule identifies potential link targets in the content of logical segments using one or more of the following:
   i. formatting including levels of indentation and numbering
   ii. available styles
   iii. content
   iv. predefined definitions
   v. hidden text
   vi. embedded links;
running the at least one linking rule over each logical segment thereby creating a collection of potential links which comprise the at least one unique identifier of the target;
storing the at least one unique identifiers of the targets within the content of the logical segments displaying the marked up content of the logical segments;
iteratively repeating the steps of running the at least one linking rule over each logical segment and reporting the collection of potential links until such time that the collection of potential links have been indicated to be acceptable by reference to received input;
creating a store of actual segments to be published, wherein each actual segment corresponds to a logical segment and is markedup with the potential link targets to other documents in the store and wherein each actual segment is referenced in the store by its at least one unique identifier and metadata;
creating actual links from the potential links by comparing the at least one unique identifier contained in the markup associated with the potential link with at least one unique identifier of the actual segment to be published; and
publishing the contents of the store.

Preferably, there the logical segments are associated with a GUID as the unique identifier.

More preferably, the logical segments are associated with the GUID and also a PagelinkRef as two unique identifiers.

It is preferred that the contents of the store can be published as static HTML files.

In a preferred embodiment, the contents of the store can be published via a compatible content management system in dynamic or static form.

Preferably, the contents of the store can be exported to any user defined XML schema as flat text in either integrated or segmented format.

More preferably, there is a further step of applying any combination of the following:
cleaning rules, substitution rules.
substitution rules.
accessibility and compliance rules

According to a fifth aspect of the invention there is provided a method for comparing and versioning documents already published in accordance with the present invention, such that the updated published documents can maintain the links to and from them such that third parties can rely on existing links that will not break (persistent linking) the method comprising the following steps:
receiving at least one segmentation rule for identifying metadata in at least one document's structure by reference to one or more of the following:
   i. formatting including levels of indentation and numbering
   ii. available styles
   iii. content
   iv. predefined definitions
   v. hidden text
   vi. embedded links;
running the at least one segmentation rule over the at least one document to identify the metadata
displaying potential segmentation points based on the metadata identified by the running of the at least one segmentation rule;
iteratively repeating the steps of receiving at least one segmentation rule and running over the at least one document and displaying the identified potential segmentation points until such time that the displayed identified potential segmentation points have been indicated to be acceptable by reference to received input;
segmenting the at least one document into logical segments associating at least one unique identifier along with the metadata that was used to display the acceptable potential segmentations points with their associated logical segment;
defining at least one linking rule for identifying potential links between the logical segments identified by their at least one unique identifiers wherein the linking rule identifies potential link targets in the content of logical segments using one or more of the following:
   i. formatting including levels of indentation and numbering
   ii. available styles
   iii. content
   iv. predefined definitions
   v. hidden text
   vi. embedded links;
running the at least one linking rule over each logical segment thereby
creating a collection of potential links which comprise the at least one unique identifier of the target;
storing the unique identifiers of the targets within the content of the logical segments displaying the marked up content of the logical segments;
iteratively repeating the steps of running the at least one linking rule over each logical segment and reporting the collection of potential links until such time that the collection of potential links have been indicated to be acceptable by reference to received input;
creating a store of actual segments to be published, wherein each actual segment corresponds to a logical segment and is markedup with the potential link targets to other documents in the store and wherein each actual segment is referenced in the store by its at least one unique identifier and metadata;
creating actual links from the potential links by comparing the at least one unique identifier contained in the markup associated with the potential link with at least one unique identifier of the actual segment to be published;
publishing the contents of the store;
taking at least one modified version of the at least one source document previously published and applying segmentation and linking rules to them
correlating the newly segmented actual segments with the existing actual segments contained in the store;
assigning the correlated segments the unique identifier of the previously published segments, and where no correlation can be made, assigning new unique identifiers to those segments;
storing the segments using the unique identifiers;
publishing the contents of the store, wherein the address and/or location of each updated document segment referred to by each entry in the store remains unchanged from the address and/or location of the existing document segment which it replaced.

Preferably the contents of the store can be published as static HTML files and wherein the at least one unique identifier is included in the HTML files filename.

More preferably the contents of the store can be published via a dynamic or static content management system that is structure agnostic and that utilises the at least one unique identifier of the present invention either as a unique identifier or as a means to mapping with its own internal unique identifier.

It is preferred that previous versions of the updated segments are being maintained in the store.

In a preferred embodiment the analysis of the document structure includes examining the documents formatting, content, textual patterns and style application to identify the at least one document's structure.

Preferably, the analysis of the documents structure includes analysing the links and references contained within the at least one source document.

More preferably, the segmentation rules run over the at least one source document are suggested to the user based on the analysis of the document structure of the at least one document.

It is preferred that the segmentation rules automatically identify to the user potential segmentation points based on the at least one source document's use of formatting, content, textual patterns, style application and any combination of those to identify documents structure contained within the at least one source document.

Preferably, the segmentation rules are able to identify and maintain the at least one source document's structure through algorithmic pattern matching to pick up formatting and styles are not used consistently in the at least one source document.

More preferably, the algorithmic pattern matching utilises the metadata extracted from the content of the segments to identity where there is an inconsistent use of formatting and styles.

It is preferred that the logical segments are assigned a GUID as a unique identifier.

In a preferred embodiment, the logical segments are assigned a GUID and a PageLinkRef.
In a further embodiment of the invention there is provided a system for dynamically publishing documents electronically, the system comprising the following:
   storage means for storing the at least one document received from the user of the system, and for storing the actual segments of the documents once segmented,
   input means for receiving instructions from a user of a system as to the acceptability of the results of the running of the at least segmenting and linking rules over the at least one document
   processing means for running the at least segmenting and linking rules, actually segmenting the at least one document into actual segments, for resolving the potential links generated through the running of the linking rules, and for the assignment of unique identifiers and unique metadata extracted through the running of the segmentation rules with the actual segments
   output means for exporting the ready to be published documents by reference to their unique identifier and metadata

Preferably the system is adapted to further receive and amended document for republishing, and wherein the processing means is further adapted to correlate the actual segments of the at least on document sought to be republished through the use of the metadata generated through the running of the at least one segmentation rule and wherein if a segment is correlated between versions, the newer segment is assigned the unique identifier of the earlier version before the segments are republished.

Preferably the system is further comprised of a communications module for communicated with connected and authorised users and wherein the information processing means is adapted to facilitate the collaboration of the authorised users for the joint authorship of complex documents wherein the information processing means is adapted to:
segment at least one document into actual segments
automatically link actual segments to form a website from desktop documents
provide access to authorised users wherein authorised users are able to check out segments of the at least one desktop document and revise the contents of the same, check the document back, wherein all versions of a document segment are kept in the document store for revision by authorised users who can author the document in separate workflows and wherein the individual segmented documents can be reassembled to form a desktop document for consumption/publishing.

Preferably the method for versioning documents can be preferably adapted to provide a collaborative authoring environment; wherein the method comprises:
importing one or more documents and applying the segmentation and linking rules for the creation of a website of many individual children pages that are tied back to the original document;
providing a workflowID to each workflow of the project which are all associated by a common projected.
Providing an approvals regime and users authorised to check and out author documents.
Correlating the segments to determine changes made and identify version.
Obtaining input from authorised users as to which segments should be reincorporated back into the document.
Aggregating the approved segments for reincorporation back into the document for publishing or subsequent use.

### BRIEF DESCRIPTION OF THE DRAWINGS

An embodiment or embodiments of the present invention will now be described, by way of example only, with reference to the accompanying drawings, in which:

FIG. 1 is a flowchart of the method of publishing a large number of documents.

FIG. 1a is a flowchart of the method of republishing a large number of documents whilst maintaining persistent third party links.

FIG. 2 is an overview of rules utilised according to one aspect of the present invention.

FIG. 3 is a screenshot showing the creating of a new electronic publishing project and organising it into multiple sub-projects if required.

FIG. 4 is a screenshot showing the creating of a new processing job within the publishing project.

FIG. 5 is a screenshot showing the addition of new documents into a processing job of an electronic publishing project.

FIG. 6 is a screenshot showing the step in which the selected documents are analysed and checked for certain issues.

FIG. 7 is a screenshot showing the selection of processing rules involved in a particular processing job.

FIG. 8 is a screenshot showing the selection of the processing steps and how they can be configured, disabled, skipped or tested.

FIG. 9 is a screenshot showing the selection of segmentation rules (segmentation method).

FIG. 10 is a screenshot showing how segmentation rule can be configured using the selection of style rules and rules based on formatting similar to the style definition.

FIG. 11 is a screenshot showing the application of segmentation point rules and additional inclusion and exclusion rules.

FIG. 12 is a screenshot showing the configured segmentation method, that is a collection of all the segmentation rules, required to identify each level of the at least one document's hierarchical structure. It also shows manipulation of segment metadata rules.

FIG. 13 is a screenshot showing the manipulation of page metadata rules.

FIG. 14 is a screenshot showing the rules for gathering metadata from previous document structure levels.

FIG. 15 is a screenshot showing the further definition of rules for gathering metadata from previous document structure levels and rules in relation to content.

FIG. 16 is a screenshot showing the application of linking rules.

FIG. 17 is a screenshot showing the further application of linking rules.

FIG. 18 is a screenshot showing the application of a new finking rule.

FIG. 19 is a screenshot showing the addition of a segmentation rule to the processing job.

FIG. 20 is a screenshot showing the selection of cleaning rules.

FIG. 21 is a screenshot showing processing rules.

FIG. 22 is a screenshot showing the project summary screen.

FIG. 23 is a screenshot showing the processing of documents.

FIG. 24 is a screenshot showing the selective updating of a website.

FIG. 25 is a screenshot showing the addition of new files to a website.

FIG. 26 is a screenshot showing the successful addition of new content.

FIG. 27 is a block diagram showing the logical components of an electronic publishing system according to one aspect of the invention.

FIG. 28 is a block diagram showing the logical components of the Process Manager.

FIG. 29 is a block diagram showing the logical components of the Import Engine.

FIG. 30 is a block diagram showing the logical components of the Auto Transform Engine.

FIG. 31 is a block diagram showing the logical components of the Manual Transform Engine.

FIG. 32 is a block diagram showing the logical components of the Edit/Replace Engine.

FIG. 33 is a block diagram showing the logical components of the Sweeper Engine.

FIG. 34 is a block diagram showing the logical components of the Meta-Data Engine.

FIG. 35 is a block diagram showing the logical components of the Link Engine.

FIG. 36 is a block diagram showing the logical components of the Preview Engine.

FIG. 37 is a block diagram showing the logical components of the Security Engine.

FIG. 38 is a block diagram showing the logical components of the Export Engine.

FIG. 39 is a block diagram showing the logical components of the Web Client Engine.

FIG. 40 is a block diagram showing the logical components of the Developer Engine

FIG. 41 is a block diagram showing the logical components of the IO Engine.

FIG. 42 is a block diagram showing the logical components of the SMPT Engine.

FIG. 43 is a block diagram showing the logical components of the Reporting Engine.

FIG. 44 is a block diagram showing the logical components of the Administrator Engine.

FIG. 45 is a diagram showing the rules engine based collaboration tool.

FIG. 46 is a diagram of the rules engine based transformation service.

FIG. 47 is a diagram of the rules engine based managed services.

FIG. 48 is a diagram of the rules engine based services workflow.

FIG. 49 is a diagram of the rules engine based services workflow

### DETAILED DESCRIPTION OF THE INVENTION

As used throughout the disclosure, the following terms, unless otherwise indicated shall be understood to have the following meanings:

Global Unique Identifier (GUID): is a string that is assigned to a segment of a document. Once assigned to the segment, it does not change, even if the segment of the document is moved within the source document, the segment retains its original GUID, thereby facilitating the process of providing persistent links to segments of document even if the overall structure of a document changes.

PageLinkRef is the shortest meaningful unique string of characters based on metadata extracted for each segment from the content and location of the segment within the hierarchical structure of the document. It allows the segment to be described in a unique and meaningful way.

Physical Segmentation: is a method whereby large content files are broken down into unique individual content pieces that remain meaningful even if are being used in a different context.

Segmentation Rules: are logical rules, defined using regular expressions and business driven rules that describe how large content files can be broken into small pieces, so that segments remain meaningful without the context.

Segment method: includes segmentation rules that are used to identify each level in the hierarchical structure of at least one document.

Cleaning Rules: are logical rules that remove proprietary formatting and mark-up in source content to ensure compliance with a defined formatting standard.

Substitution Rules: are logical rules used to substitute text strings or content mark-up in order to comply with specific industry standards (e.g. DITA, S1000D, W3C).

Linking Rules: are logical rules that identify a total set of potential links and link points and then determine which links are to be created based on the target page availability.

Document Metadata: is information used to describe and/or classify content segments including but not limited to date information, keywords and content synopsis. Document Metadata can be used to establish cross-references, indexes and relationships between content segments.

Styles: are a collection of formatting rules defined in a source document that details how a client application should display text in the application presentation layer. Examples of commonly used styles include headings, tables, and number lists.

Processing Jobs: are a collection of segmentation rules, linking, cleaning rules, substitution rules, compliance and accessibility rules to be applied to at least one document.

Publishing Project: includes processing rules for at least one document.

Persistent Third Party Links: are links created between content segments that persist through subsequent transformation processes whereby a content segment created during the initial transformation process is allocated a GUID to which corresponding segments created during subsequent processes can be linked despite the original segment having changed its state in regards to the generated structure. If the content is published to the internet using a CMS system, and then later republished, the URL assigned to the content at first publication will continue to operate with respect to the same content upon republication, even if the content has moved within the publication.

Algorithmic Linking: algorithmically identify all possible link outcomes for a given segment or content string, using automatically identified, user identified or user generated rules.

Advanced pattern matching: uses algorithms to identify content elements (including headings, tables, lists, footnotes, image descriptions) that are not explicitly defined in source material as styles or tagged in any manner. It allows the identification and mapping of non-styled or tagged content to defined content types or styles. It also establishes the hierarchical structure a document.

Multiple comparisons between multiple versions: allows a user to compare transformed content segments through multiple versions of the segment resulting from repeated and/or subsequent transformations through an indefinite lifecycle.

Concurrent collaboration and authoring: allows multiple authors to edit transformed content segments while retaining all historical editions of the segment, Collaborative authoring of segments is interleaved with the segmentation process initiated during the transformation cycle and persistent linking is maintained through by transformation and collaborative editing activities.

Address: There are various different addressing methodology encompassed by the invention. Depending the output sought by the user of the invention, and the type of publishing method utilised, a reference to a electronic document address may comprise the following:
a. if published to a local media—an address may include the file path and filename which may be expressed in relative terms;
b. if published to a local network—an address may include a URL which encompasses the protocol type, the machine name, the directory path and the file name
c. if published by a compatible content management system—the address would include a protocol type, the machine name, and string used to identify the document's database entry in the CMS

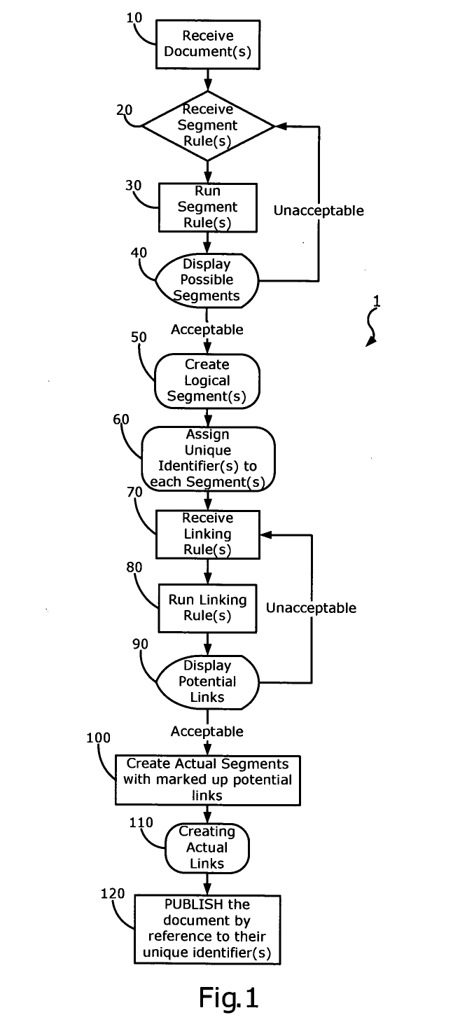

FIG. 1 depicts a flowchart comprising the steps of the method according to one aspect of the invention where documents are published for the first time. FIG. 1a depicts a flowchart comprising the steps of the method according to a further aspect of the invention where documents are amended and republished and where persistent third party links are maintained.

Referring to FIG. 1, the method of the present is implemented as follows. The system first receives 10 documents. The system then receives input from the user of the system which effectively provides the system with direction to receive 20 one or more segmentation rules. These rules may be suggested by the system as a result of an initial analysis step (not shown) whereby the document's structure is analysed and appropriate segmentation rule suggested to the user of the system. Once the system has received 20 the segmentation rule or rules the system runs 30 the segmentation rules and displays 40 the possible segmentation points based on metadata extracted by the running of the rules.

If the displayed 40 potential segmentation points are acceptable to the user of the system they indicate this by providing their command that the displayed 40 points are acceptable and the system thereafter creates 50 logical segments and in the process, assigns 60 at least one unique identifier and the metatdata used to segment the logical segments to each logical segment.

The system then received 70 a linking rule(s) from the user of the system which is run 80 over the logical segments in order to display 90 the potential links between logical segments. Just as in the case of the application of the segmentation rules, if the displayed potential links are not acceptable then the linking rule is modified and reran 80 until such time as the displayed 90 potential links are acceptable to the user of the system. In such case the logical segments are transformed 100 into actual segments with marked up potential links. These actual segments are then processed 110 to create actual links from the potential links by looking at the targets contained in the potential links. These targets include reference to the unique identifier assigned to the logical segment and the process involved in processing 100 them to obtain actual links involves looking up the unique identifier contained in the targets to see if they correspond to actual to logical segments possessing that unique identifier. If they do then an actual link is created 110 before the documents are published 120. In preferred embodiments the documents are published 120 by reference to their unique identifier which as will be seen, will facilitate third party persistent linking as seen by reference to FIG. 1a.

FIG. 1a refers to an alternate embodiment of the invention in which amended documents previously published are republished in accordance with the method of the invention. Before the present embodiment can be carried out by the system, a first set of documents must be published in accordance with steps 10-120 as previously described. In particular it is mandatory that the publication 120 occur by reference to the unique identifier associated with each document published. In particular the documents address needs to be dependant on the unique identifier or indeed may be made to be the unique identifier.

After the first set of documents are processed in accordance with steps 10-120 a second set of amended documents are received 210 by the system. Thereafter the processing of these documents is identical to steps 20-110 of FIG. 1 and as shown in steps 220 to 310 of FIG. 1a. After the documents have had their actual links created 310 they are correlated 330 with the previous set of documents that were previously published in step 120.

The system correlates those sections using the unique metadata extracted by the running of the segmentation rules in steps 30 and 230 and which was associated with the logical segment and actual segments in subsequent steps.

To the extent that the system is able to identify a matching segment in which no changes have been made it takes the unique identifier previously associated with the originally published segment and assigns 340 that unique identifier to the new segment which represents that same segment.

If the system cannot match one of the new segments with one of the old segments, that means that the content of that segment is changes or is new, and in that case the system assigns 350 a new unique identifier to that segment. Thereafter the system takes all of the segments and publishes them by reference to their unique identifier. In that way links to the older, unchanged segments will still possess the same address or URL even though technically it is a substituted document segment. This is how persistent third party links are obtained and maintained.

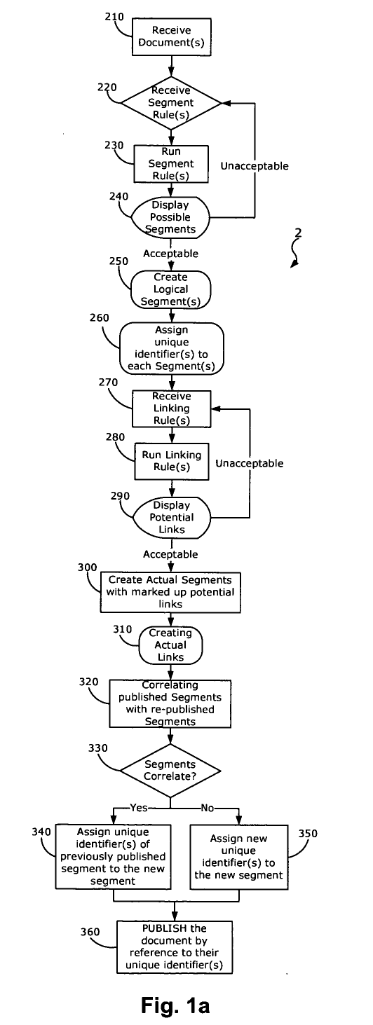

FIG. 2 depicts a diagram depicting various rules which are processed by the present invention.

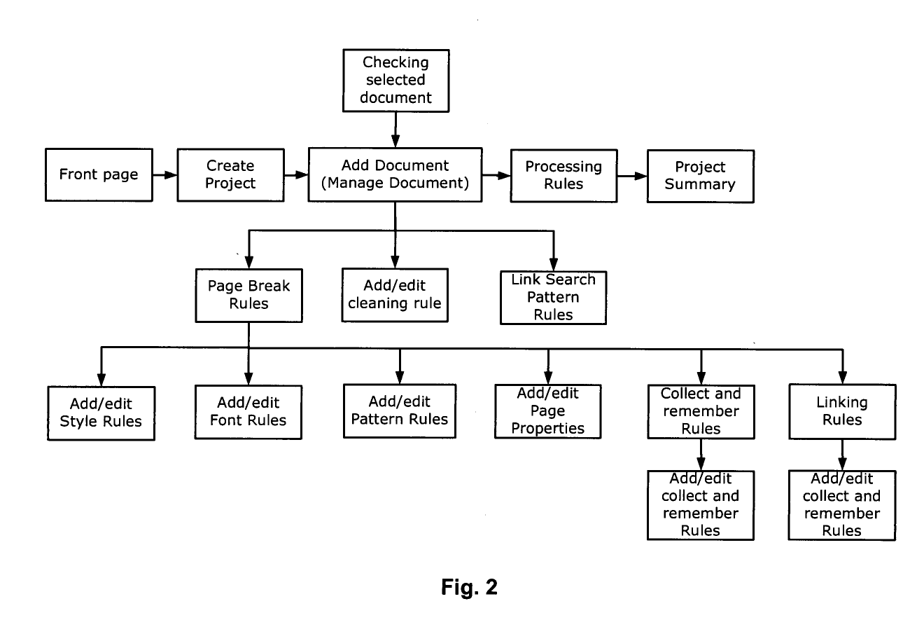

FIG. 3 depicts the first step 130. In the present example, the use of the system creates a new project. The user can also organise the project into multiple sub-projects.

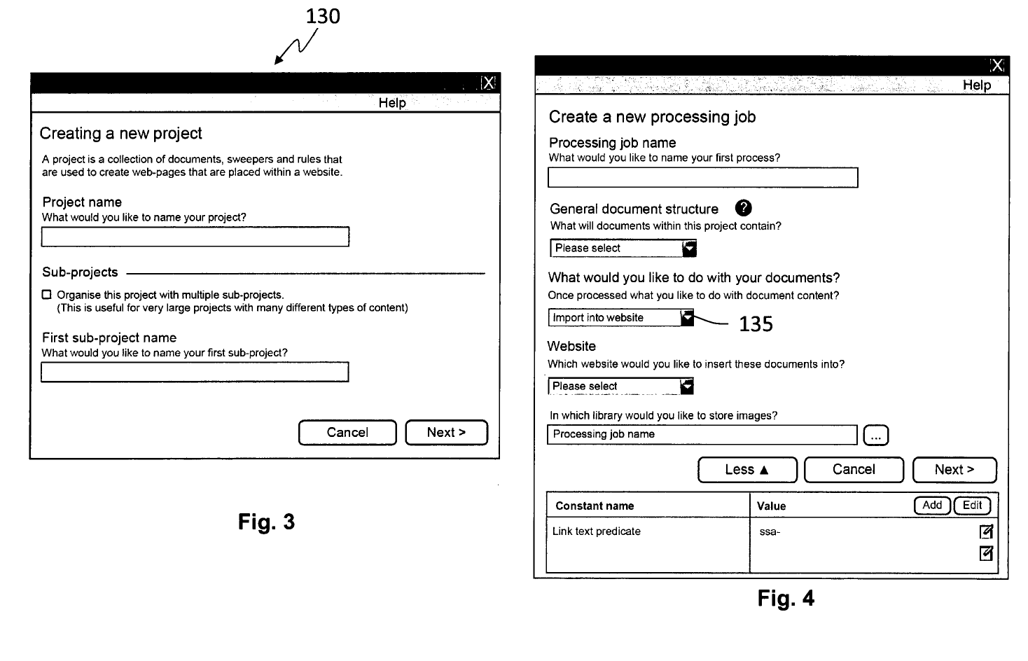

In FIG. 4 the user is presented with a number of output options 135, which include publishing the output content to static website files, to a CMS, and to other formats including PDF (Adobe Portable Document Format developed by Adobe Inc.).

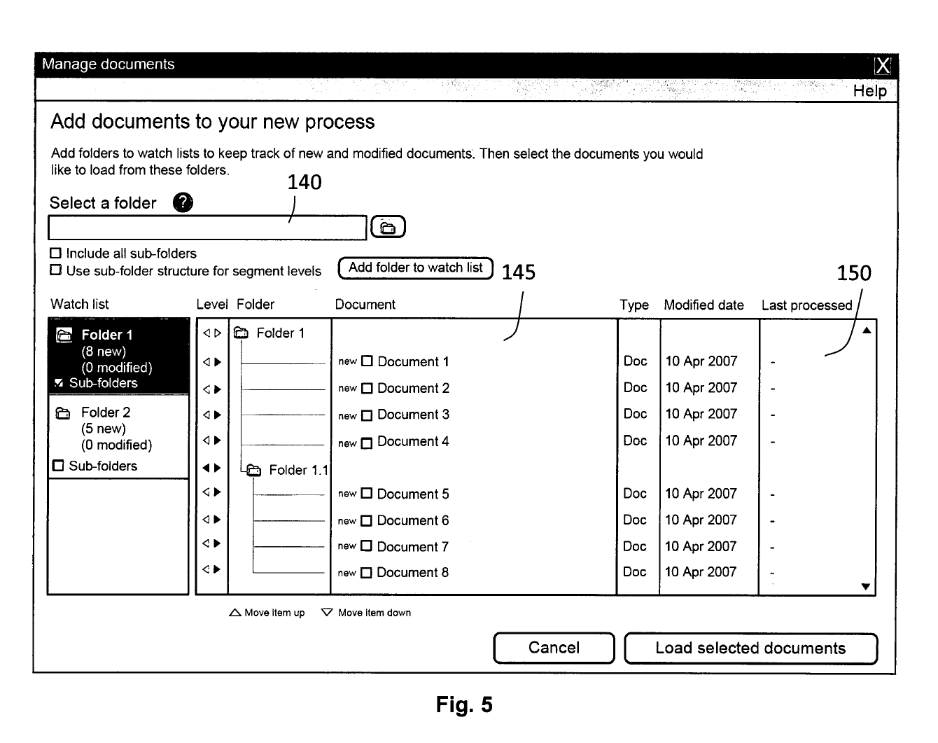

The user of the system then adds documents as depicted in FIG. 5. In this figure the user can select a folder 140 that the system will thereafter keep watch of and automatically add files from. Otherwise the user can enter selected documents manually 145. The system also keeps track on whether the document was previously processed and informs the user of the last time the document was processed 150.

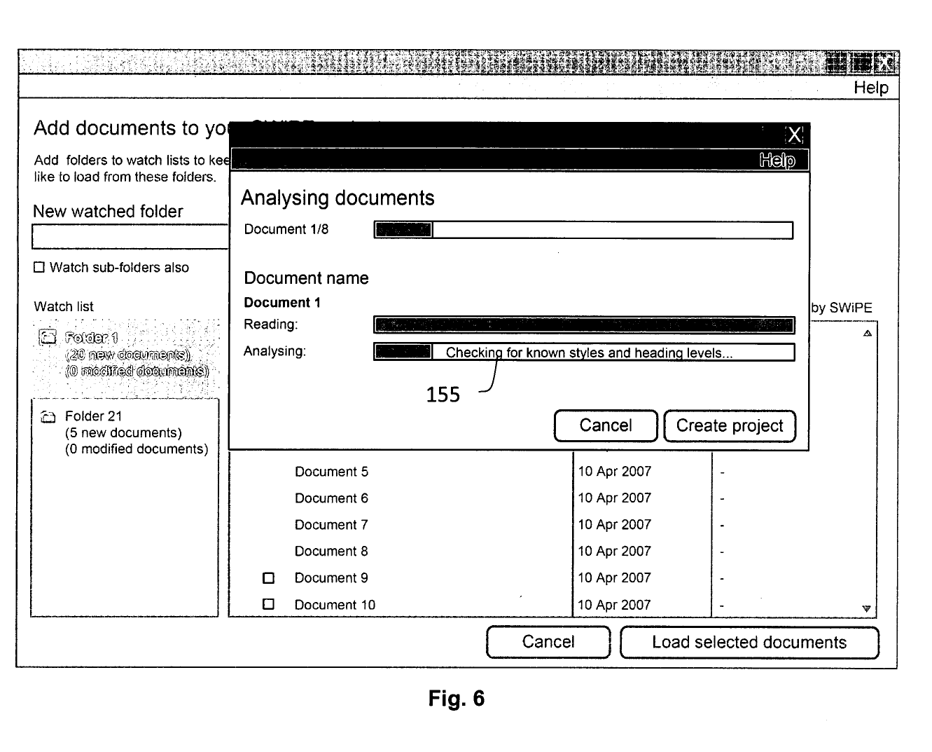

FIG. 6 depicts the first stage of the second step which involves preparing the documents according to the present invention. The documents added to the project in the previous step are analysed 155 for any potential issue that may disrupt later processing and brings it to the attention of the user at an early stage.

At this stage, the styles used to mark up the document are also analysed 155 for future suggestion of appropriate rules for further processing. In particular, overt styles, such as those defined by the user and applied as a Heading Style in the manner common to users of Microsoft Word, and also those subjective styles which can be identified through the examination of font size, font type (i.e. bold), typeface, levels of indentation and numbering.

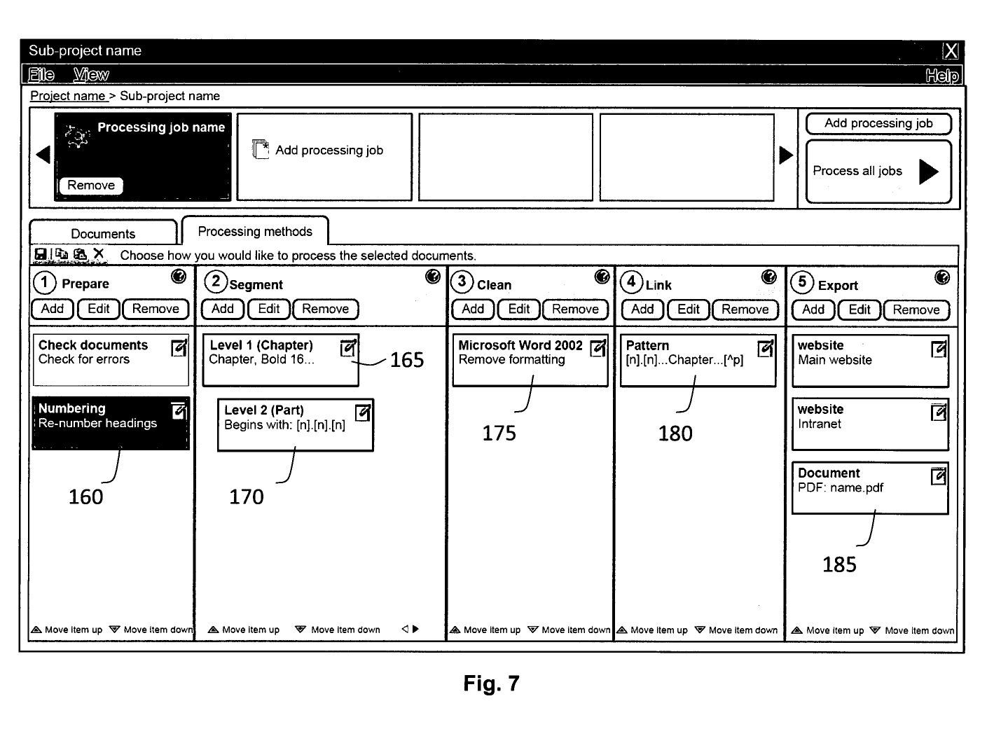

FIG. 7 depicts the second stage of the second step in which the user selects rules for processing the added documents. Initially, the system provides the user with a number of predefined styles and rules based on the initial analysis of the source documents.

For example, if the system detected that the source documents contained legislation, the system suggests a first set of rules including preparation, segmentation, cleaning and link selection rules that looked like they would be appropriate to the specific source documents. These suggestions are derived from both instances of past processing of similar documents, and can also be built-in for the first time documents are processed by the system, based on common document types such as legislation.

For example, the first rule to be suggested, rule 160, is a document preparation rule which will correct inconsistencies in the source documents and correct heading numbering. Rule 165 is a segmentation rule which would logically split documents at a primary level based on the identification of the Microsoft Word style “Chapter”. When run, this rule would logically segment the document such that each segment begins with the content identified by the first rule 165. The same segmentation rule 165 will look for a specific formatting, in particular, bold characters of 16-point size without relying on the Microsoft Word style name to split documents at the primary level. The second rule 170 is also a segmentation rule, but in this case the rule is searching for a pattern of text using wildcards where ‘n’ is a number.

The cleaning rules are suggested when during the initial analysis of the source documents, problems with the underlying format of the documents requires rectification. These problems are often encountered with Microsoft Word files which are notorious for their proprietary formats and which are difficult to work with, especially with respect to figures, tables, and internal links which are often present in the document, but are broken.

In the present case, as depicted in FIG. 7, the cleaning rule 175 has been suggested to the user to remove this additional formatting. During the cleaning step substitution rules, accessibility and compliance rules can also be applied.

Link search pattern rules are those that seek to identify all the potential future links, based on references with an identifiable structure (pattern) in the content of each segment. Link search pattern rules assign unique identifiers or page link references (‘PageLinkRef’) that will subsequently be used to identify the matching target segment for each link. For example, in FIG. 7 rule 180 would seek to find any number followed by a period and another number and a paragraph mark.

The user is also presented with a number of output options 185 (see FIG. 7), which include publishing the output content to static website files, to a CMS, and to other formats including PDF (Adobe Portable Document Format developed by Adobe Inc.).

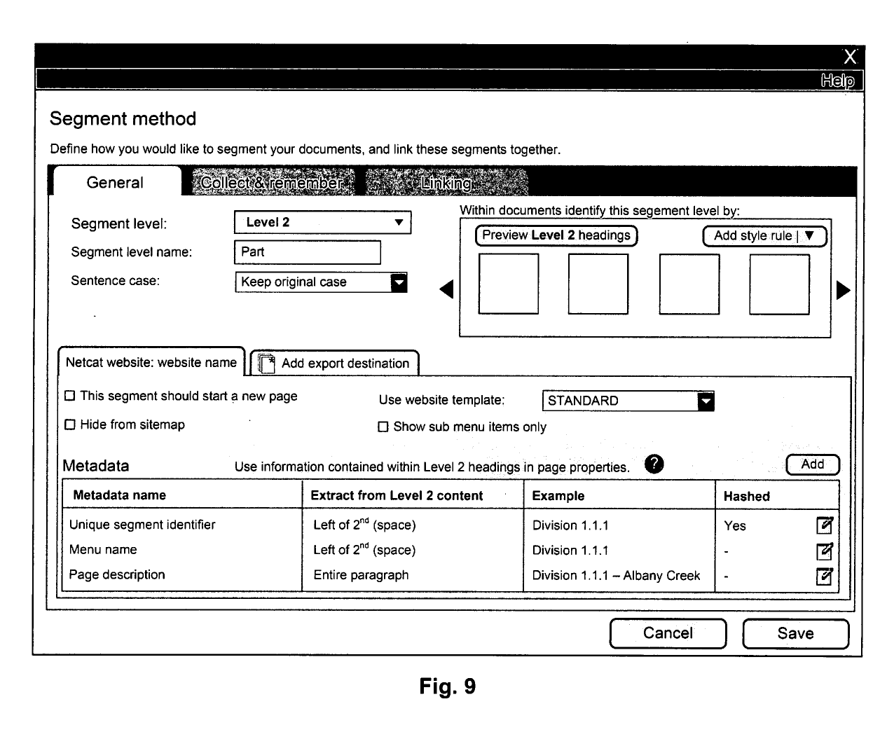

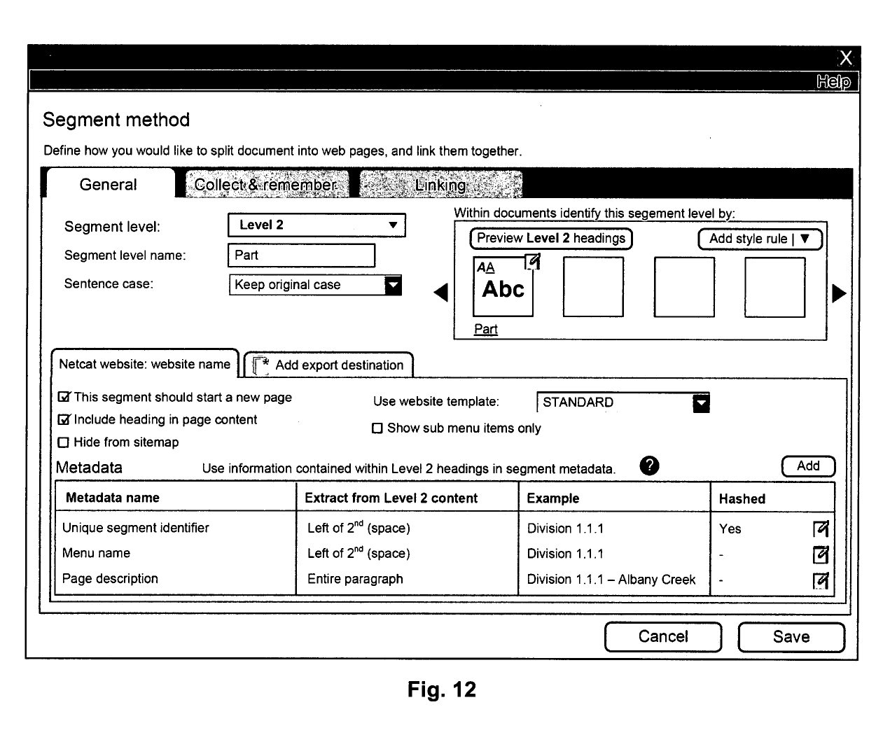

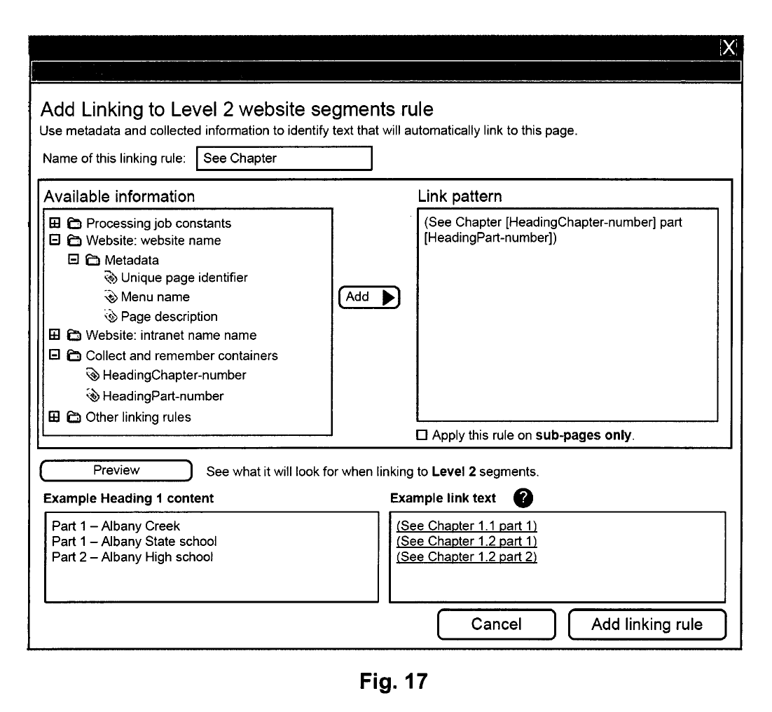

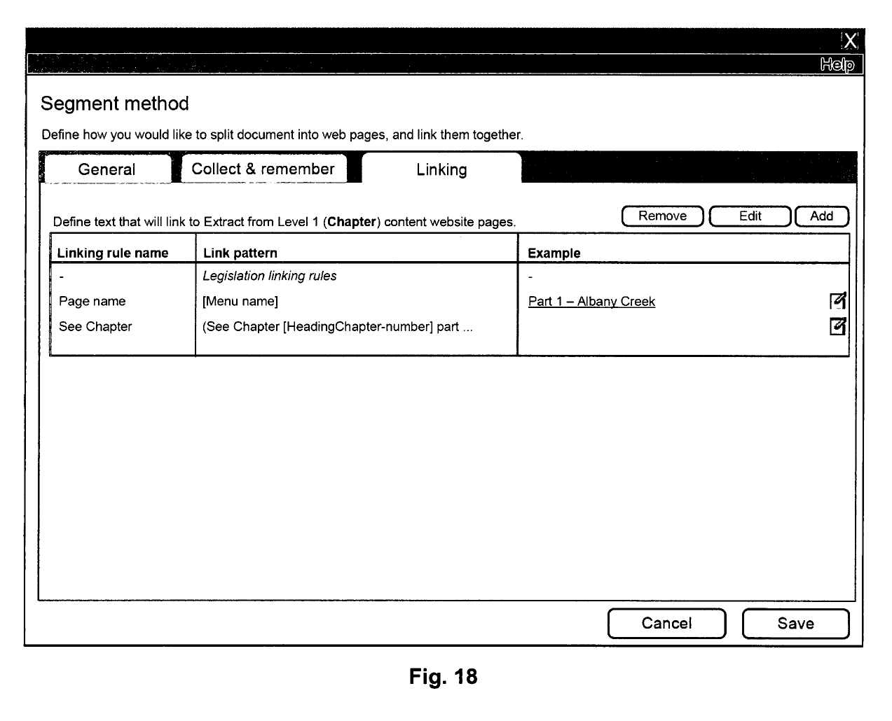

If the user is not satisfied that the rules presented by the system are appropriate for the source document or documents, the user can redefine the rules or define new ones. The creation of alternate rules is depicted in FIG. 9 to FIG. 22.

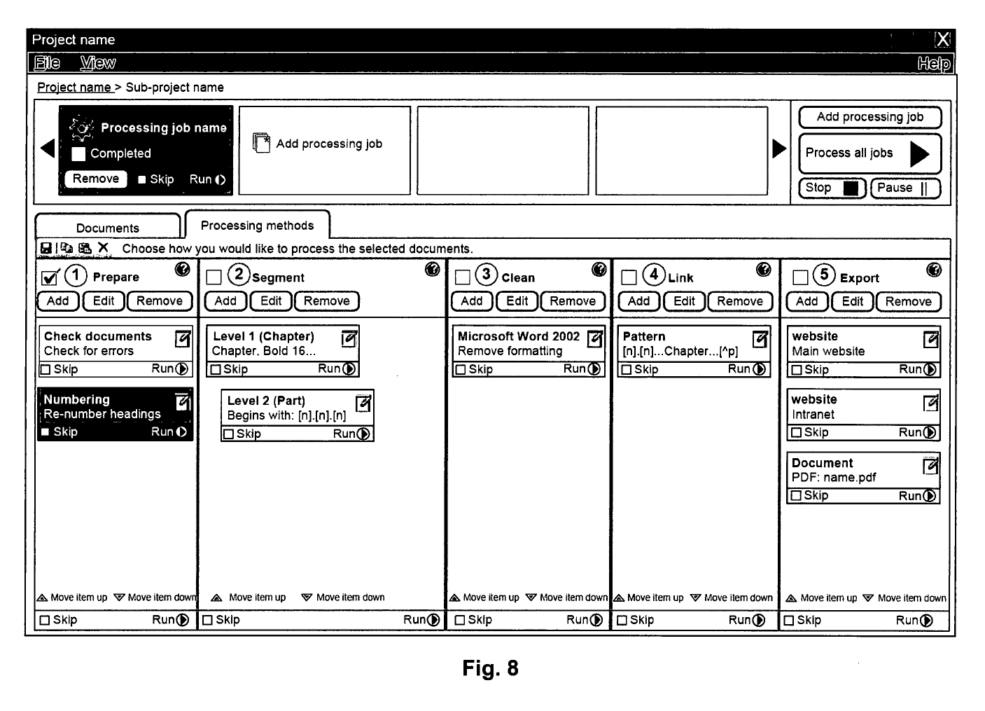

FIG. 8 shows the selection of the processing steps and how they can be configured, disabled, skipped or tested. In the example screenshot only the preparation step is to be executed.

FIG. 9 depicts the third stage of the method. In the third stage the user configures the segmentation method for the ‘part’ level in the hierarchical structure of the document.

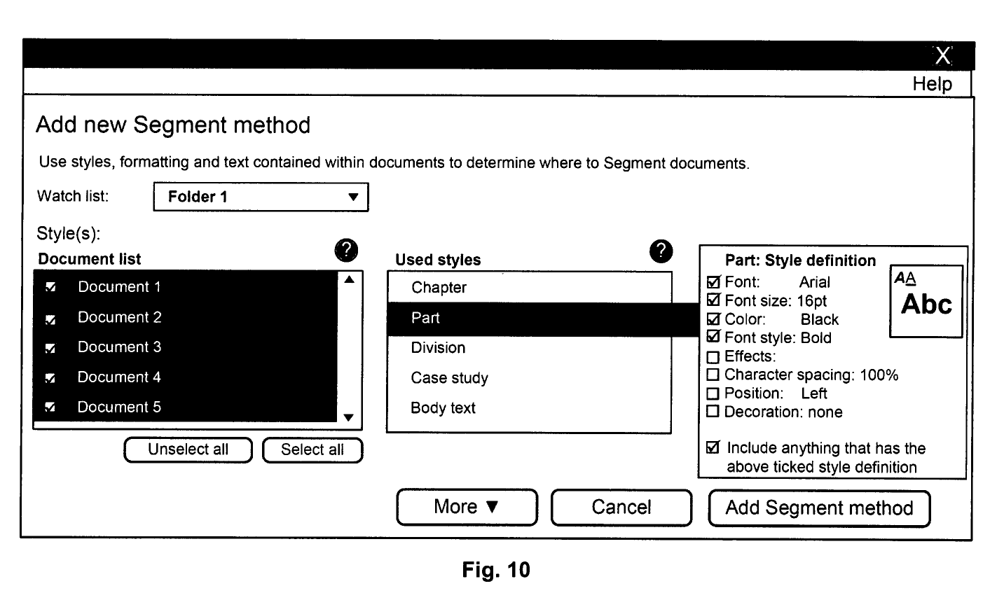

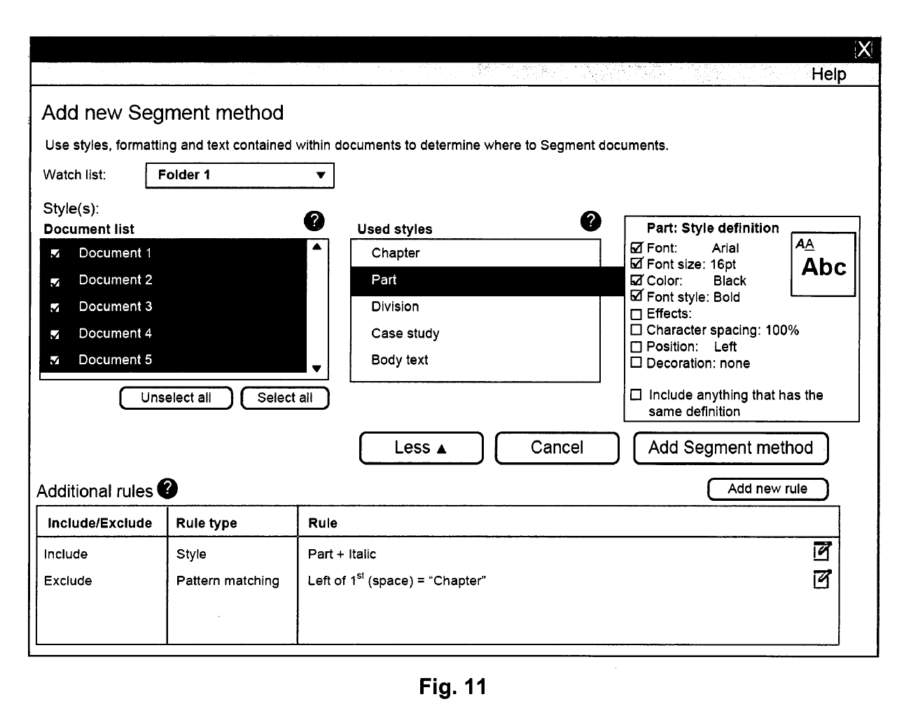

FIG. 10 depicts the user selecting a Style rule to the segmentation method of FIG. 9, and FIG. 11, the resultant screen which shows that the style “part” has been selected. Segment metadata rules can also be added to a segmentation method.

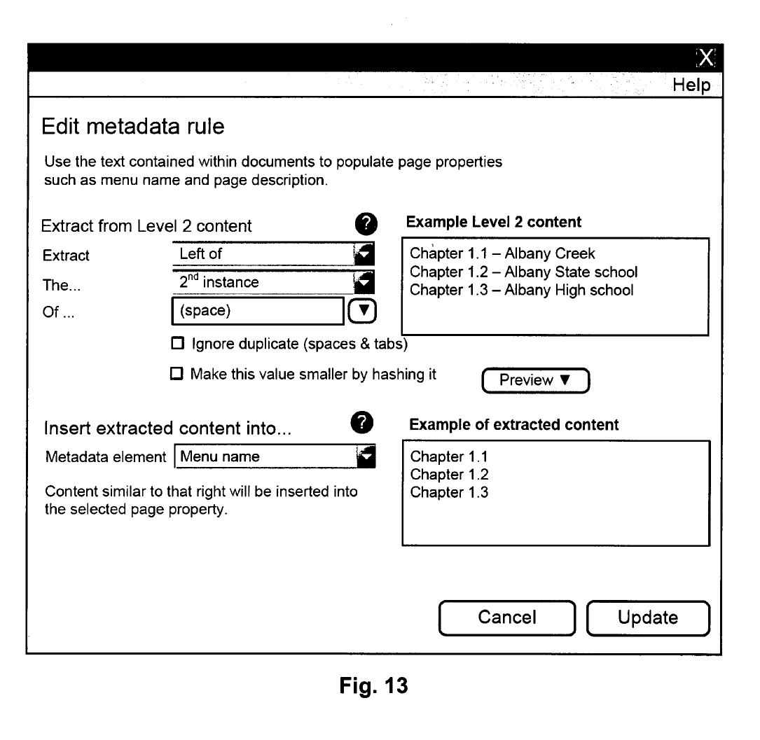

FIG. 13 shows how a rule is defined to create rnetadata for a content segment based on the automatic extraction of content from the source file. The system allows users to define the extraction rules that specify what content is used to define the metadata of the content segment.

The words ‘Extract . . . the . . . 2^{nd} instance . . . of . . . space’ appears in a drop down lists which displays all the source content elements that can be used to extract the metadata item. In this particular example, text after the second instance of the space will be stored as a metadata item, which will be used for the menu display.

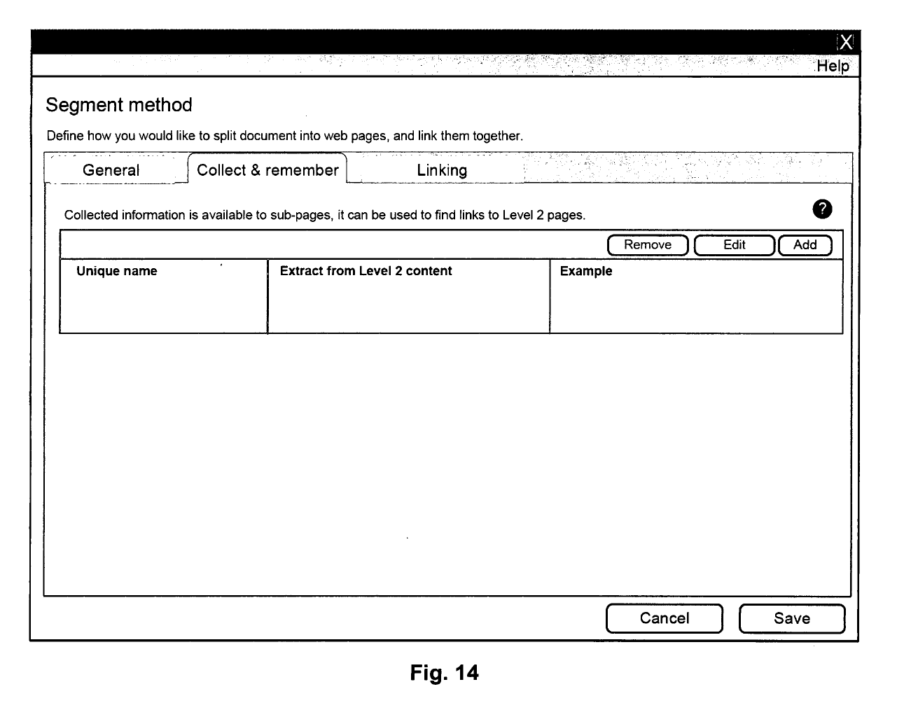

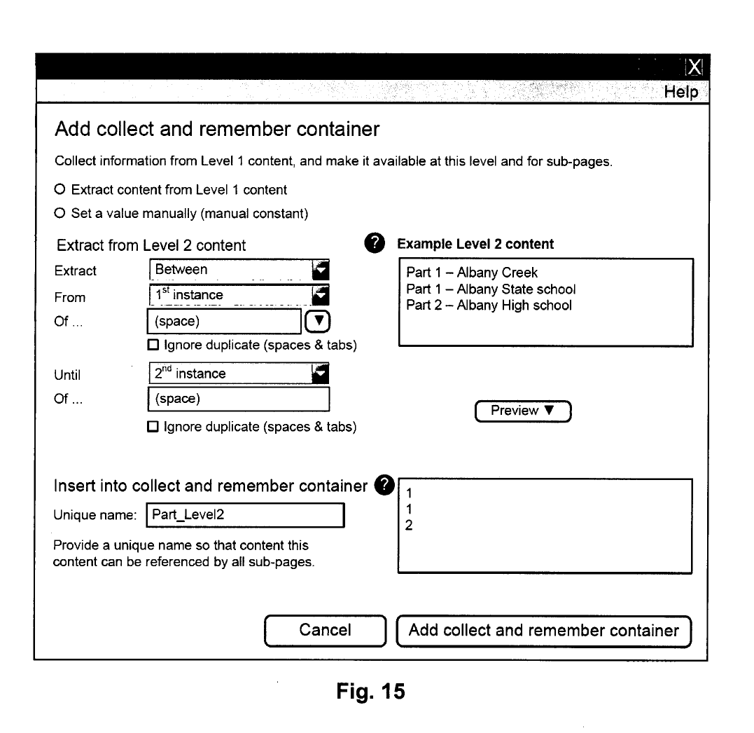

FIG. 14 and FIG. 15 depict the method whereby a user can define what extracted content items are inherited from the higher levels of the hierarchical document structure by other content segments such as part numbers, titles, metadata and other elements. This is a key capability as it allows users to create rules that can automatically execute content substitutions or alterations without explicit definition. This capability also allows users to create rules that can automatically use metadata from the higher document levels. Furthermore this capability also allows substitution and alteration of navigational elements and/or other metadata without explicit definition.

During the segmentation process metadata items from the higher document levels are stored and specific names are assigned to those items. By referring to the unique names of the metadata items the segments at the lower levels of the document can access the metadata items from the corresponding higher levels.

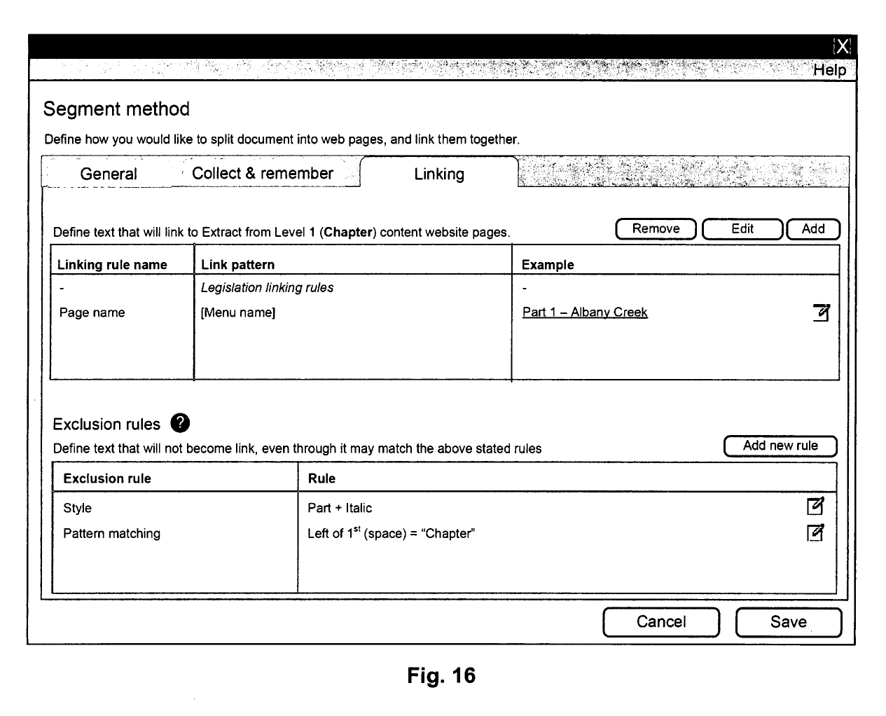

FIGS. 16 through 18 identify how users add rules to create potential links. Potential link points are automatically identified based on the algorithmic pattern matching that can also make a use of segmentation structure, content and metadata. System can assist users in defining complex algorithmic patterns that will be used in identifying potential link targets by suggesting search terms that can also include wildcards. Search terms are then presented to the user via the drop down boxes.

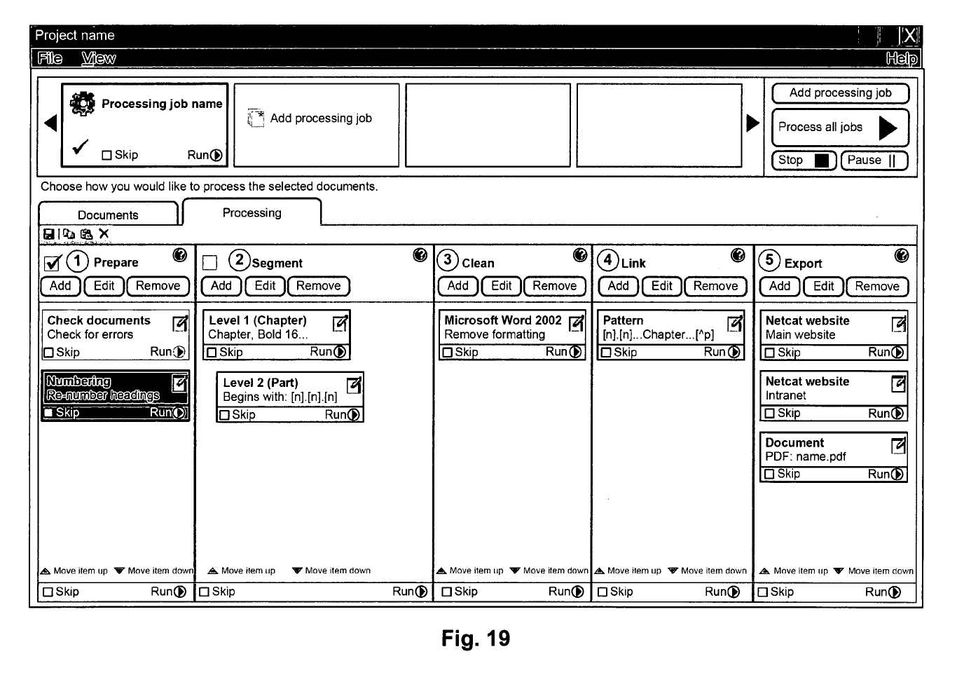

FIG. 19 is a screenshot showing the addition of a segmentation rule to the processing job.

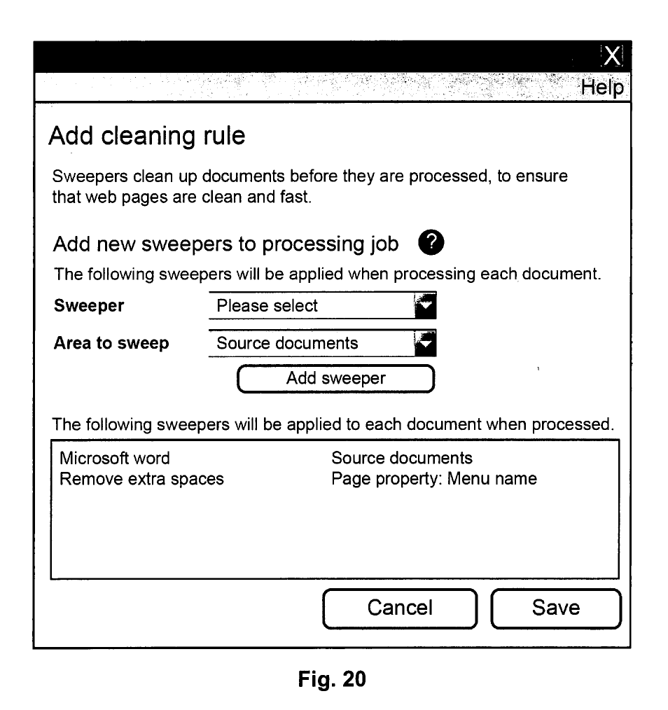

FIG. 20 shows users being able to add cleaning rules to the rule set. At this stage users can also add substitution rules, accessibility and compliance rules.

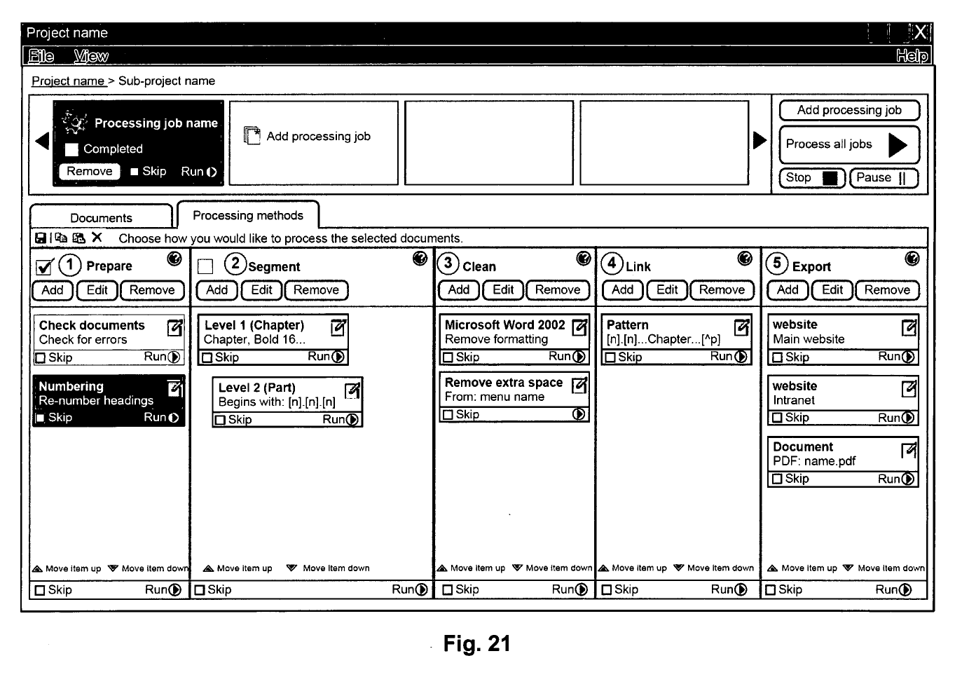

FIG. 21 is a screenshot showing processing rules.

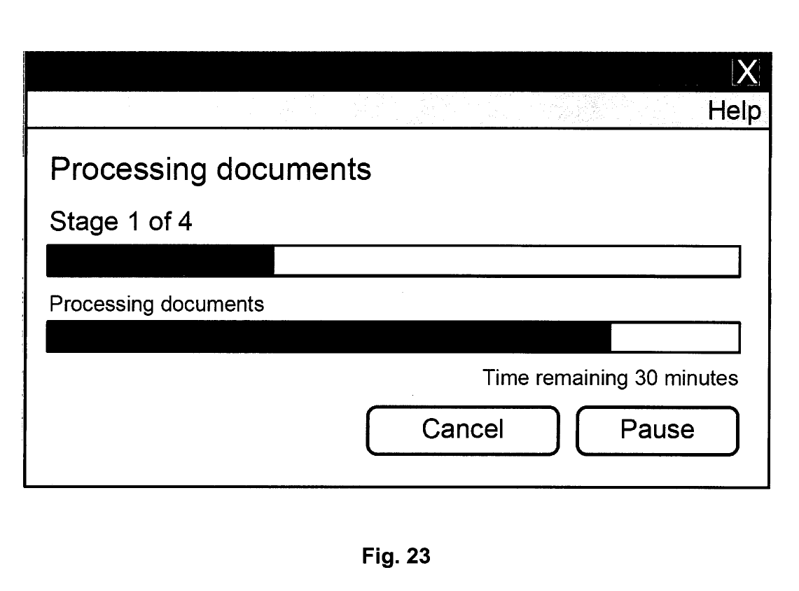

FIG. 23 is a screenshot showing the processing of documents.

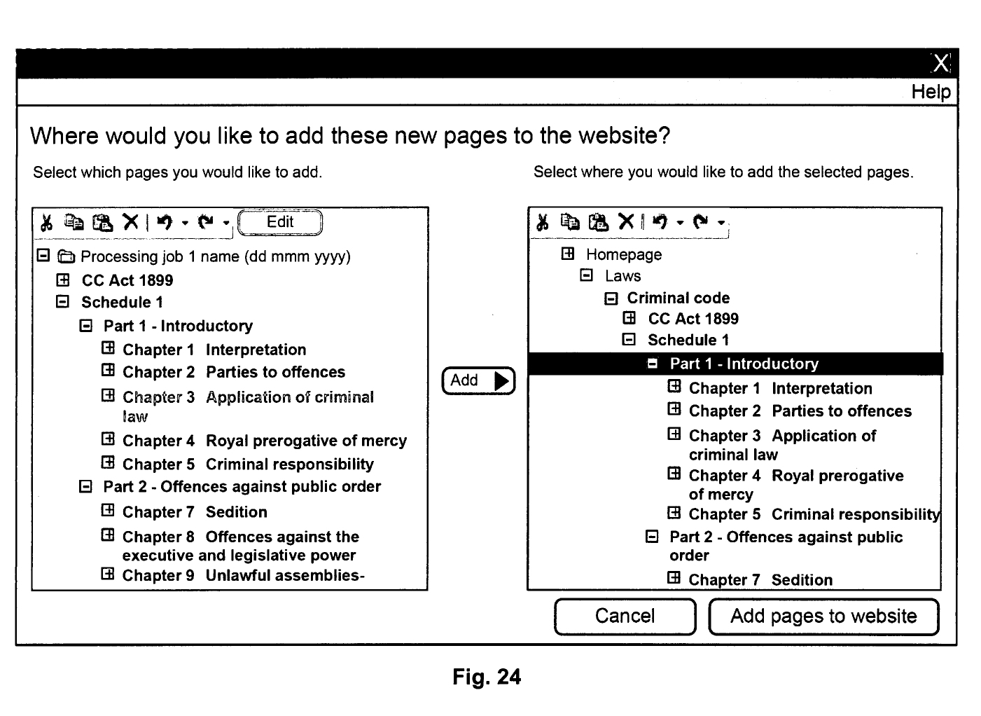

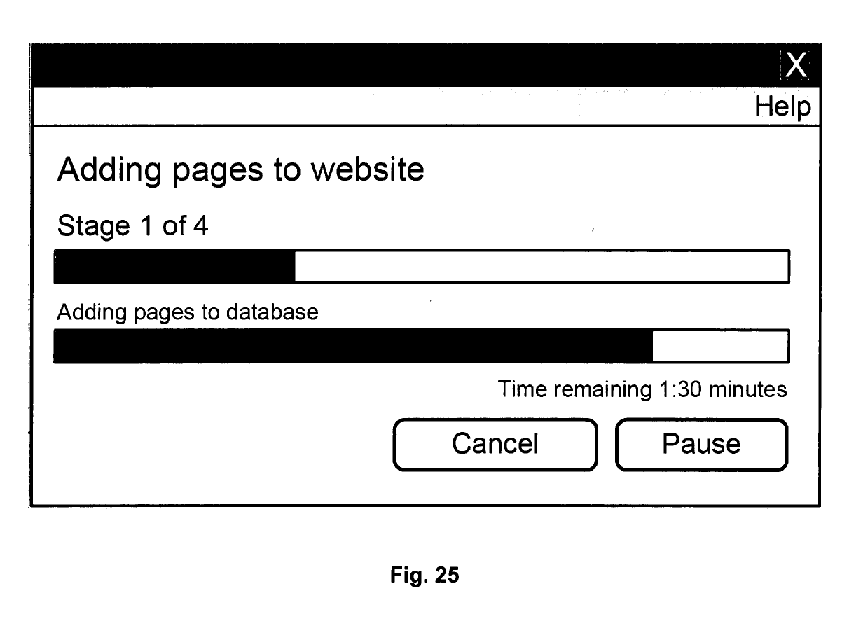

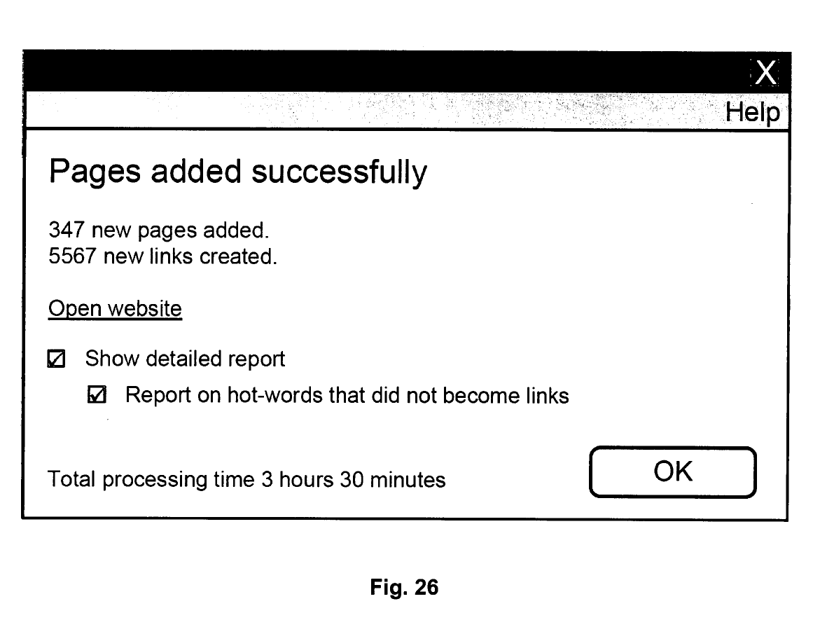

FIG. 24 shows how a user is able to ‘drag and drop’ the transformed content set into the destination system. The destination system is shown on the right and is represented as a logical tree. The user drags the content from the left hand column to the right to load the transformed content set to the destination system.

One of the major features of the present invention is the application of rules in a structured way such that the output of a higher level rule can be affected by the subsequent processing of a lower level rule. The rules, in effect, act upon each other and potentially in an iterative fashion.

For example division level segment identifiers will depend on and include higher level segment metadata items, such as part numbers. Transformations and outputs from higher level rules can dynamically affect the manner in which subsequent rules are processed. Combined with the ability to conduct the processing of the rules at various stages, including in an iterative fashion, the system is able to generate a lot of metadata, including links, in a flexible yet reliable and predictable way.

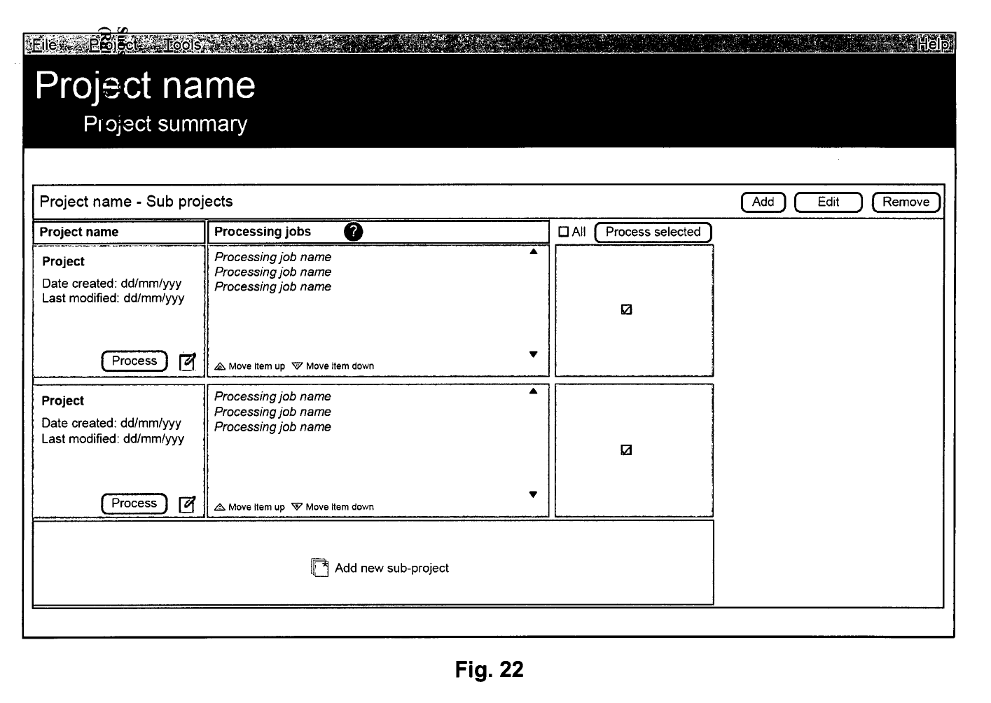

FIG. 22 depicts a screenshot of the system once all of the relevant rules have been identified the system meshes the rules into one standalone file that internally describes the structure of the documents to be processed and way in which they are to be segmented.

All of the above so far has referred to the segmentation steps of the present method. By this stage, the standalone file generated has stored within it, all of the logic for extracting metadata that uniquely described all of the logical segments of the documents. Importantly, that file has contained within it, the unique description identifiers that are used to generate the GUID's and/or PageLinkRef's that are associated with each logical segment. Further, the system has by this stage identified all of the potential links that could occur between the various sections of the source content set as well as between the source content set and the content that already exists in the destination system. Further, at this stage the source documents are unchanged and standalone from the file generated.

The fourth step 30 (refer to FIG. 2) in the method involves the source material being “cleaned”. This may involve the further processing of cleaning rules that, for example, may involve the substitution of certain text strings like phone numbers.

Continuing the present example, there might be a need to replace all instances of a phone number with a new phone number or alternative text for the graphics can be inserted for the accessibility compliance. The system uses regular expression and Boolean logic to execute such substitutions.

After cleaning, the fifth step in the method is to transform the source documents into a format appropriate to the output, format, and destination as selected by the user.

As indicated with respect to FIG. 4, the output of the system can be sent to a website, a compatible CMS, a document management system, a static drives or some other application via an ETL module (extract, transform, and load).

The most important step conducted at this stage by the system is reducing the potential links between uniquely identified segments through the use of GUIDs or PageLinkRefs assigned in previous steps, to a list of actual links with existing target pages and as required or directed by the user.

For instance, the set of potential links created in the previous step may, with respect to legislation, point to other parts of the legislation, or to related materials such as legislative commentary or guides. It is possible for the user to define which sets of links get made once the source material is actually segmented. The user may apply one rule which provides that only links to other legislation be incorporated into the final product. In other cases, links to both other sections, and guides referring to these sections be included in the final output.

Once the set of potential links has been resolved to a smaller subset of actual links, the documents are processed and a large number, potentially hundreds of thousands, of reusable content objects are output from the system.

The segments comprising reusable document objects are reusable because of the GUID and PageLinkRef strings that are associated with each of them. As these strings of data are unique, changes in the source documents only change those segments that are affected by the change in the source.

During the transformation process, a content segment is defined by identifying content blocks within the source file using unique text string combinations that exist within the source content (such as document title, section number and section title text). These items are used in the segmentation process which creates the unique identifier within the present invention.

During subsequent re-imports of the source content, the unique identifying text string combinations can be re-identified and explicitly linked to the original GUID and PageLinkRef identifiers, ensuring that re-imported content ‘overwrites’ the original content segment. In this way, the content segment remains consistent through multiple versions.

In this way, a URL pointing to a particular segment, can remain the same even if it has moved within the source document. Only changes occurring within segments result in a new GUID/PageLinkRef.

Persistent external links can therefore be generated with respect to static HTML sites, as a unique filename can be given to each segment which is then left alone unless changes occur within the segment.

Human readable URL also can be generated for each segment, based on the value of PageLinkRef that will make it easier for the external sites to link to the segments.

Alternatively, a CMS of the present invention can be used in which case the imported segments are assigned, within the CMS, a unique identifier that is actually the unique identifier used by the transformation system, or one that is mapped to this system. In doing so, the CMS can map the updated segments with respect to the existing segments, and the same URL including lookup information can be used in respect of the new segment.

As the system keeps a record of the destination system ID of the CMS, when exporting to the CMS, it can direct the CMS to replace only those segments (identified by way of GUID which remains the same even in the case of modification) that have been modified. This in turn allows for external links to be maintained across document versions.

The present invention is capable of outputting electronic documents to a variety of formats and editions from the one source including:
HTML;
XML;
PDF;
MICROSOFT HELP FILES; and
MICROSOFT WORD FILE.

Furthermore, the documents of the various formats can be output with links that are appropriate for the following repositories:
Servers;
local drives;
removable media;
PDA assistants; and
Web.

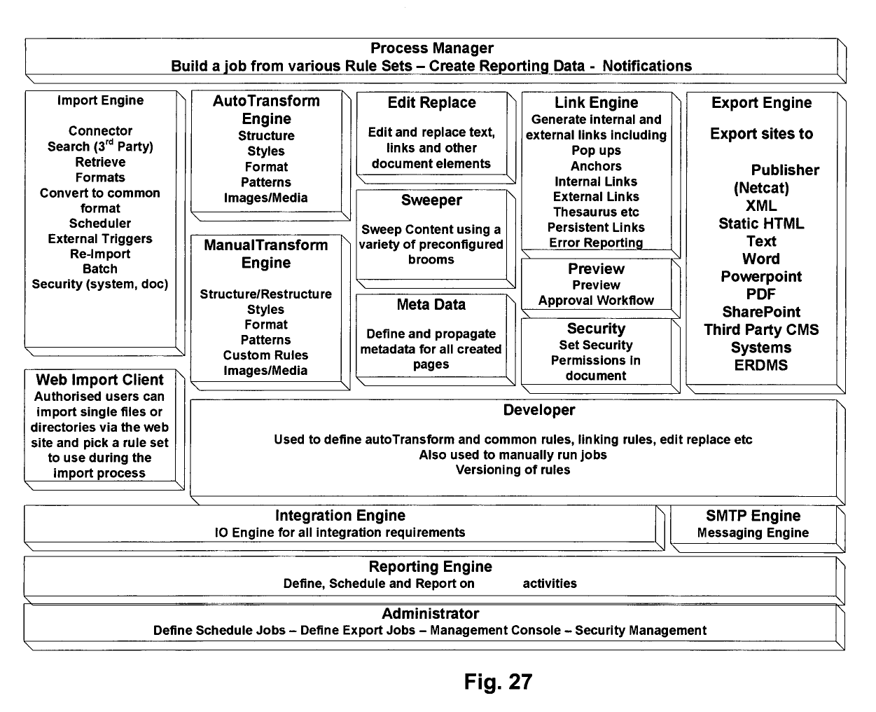

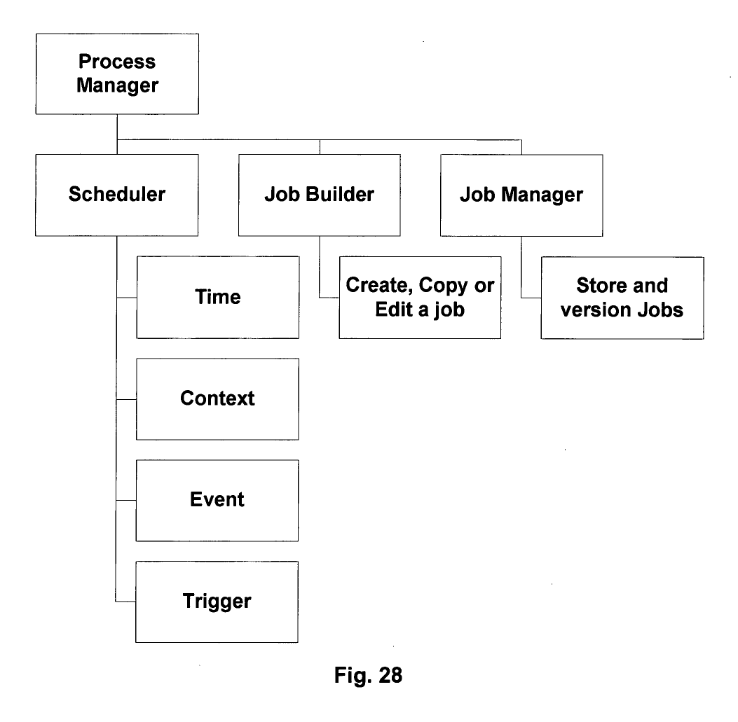

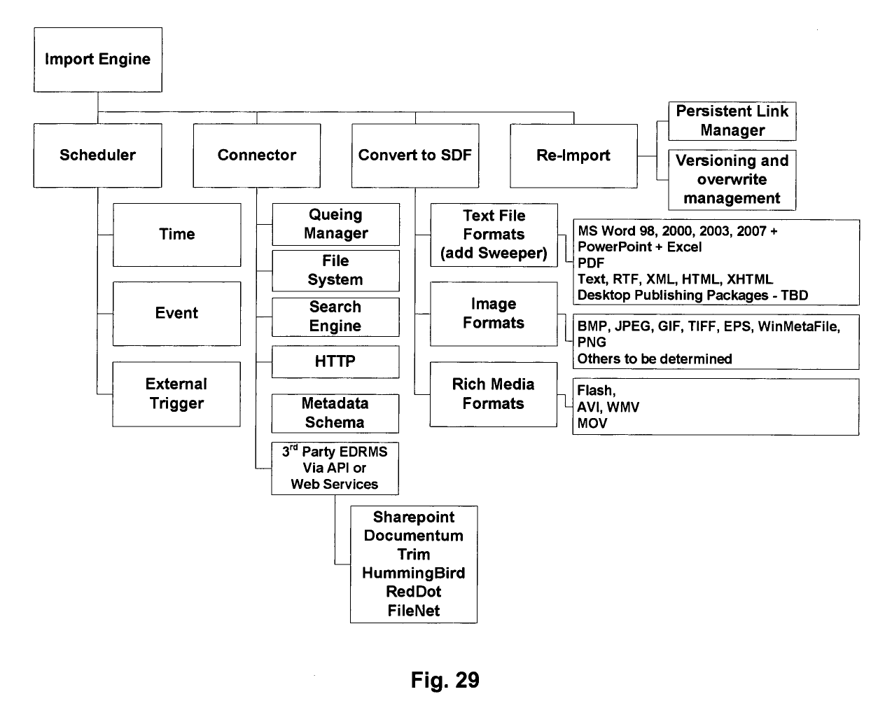

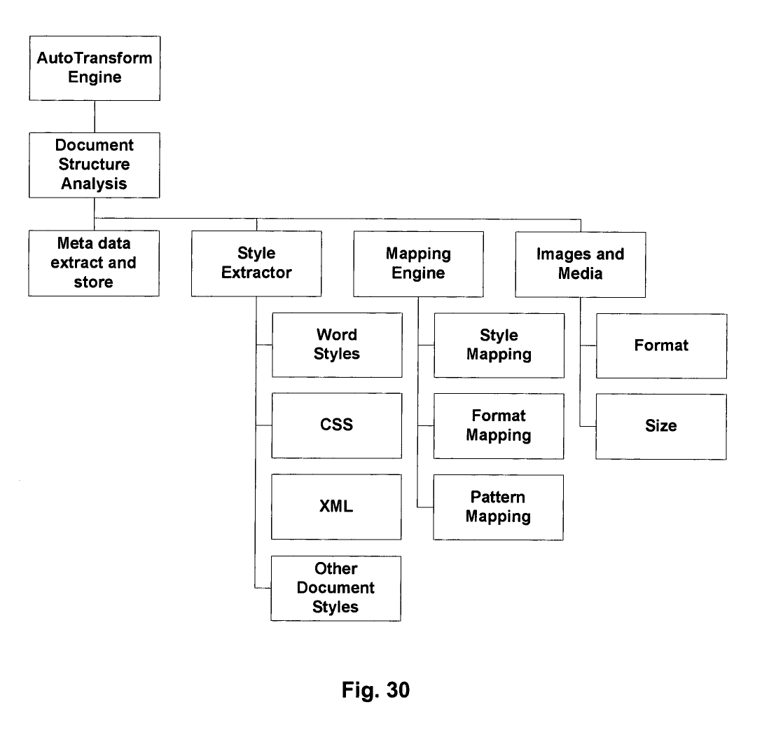

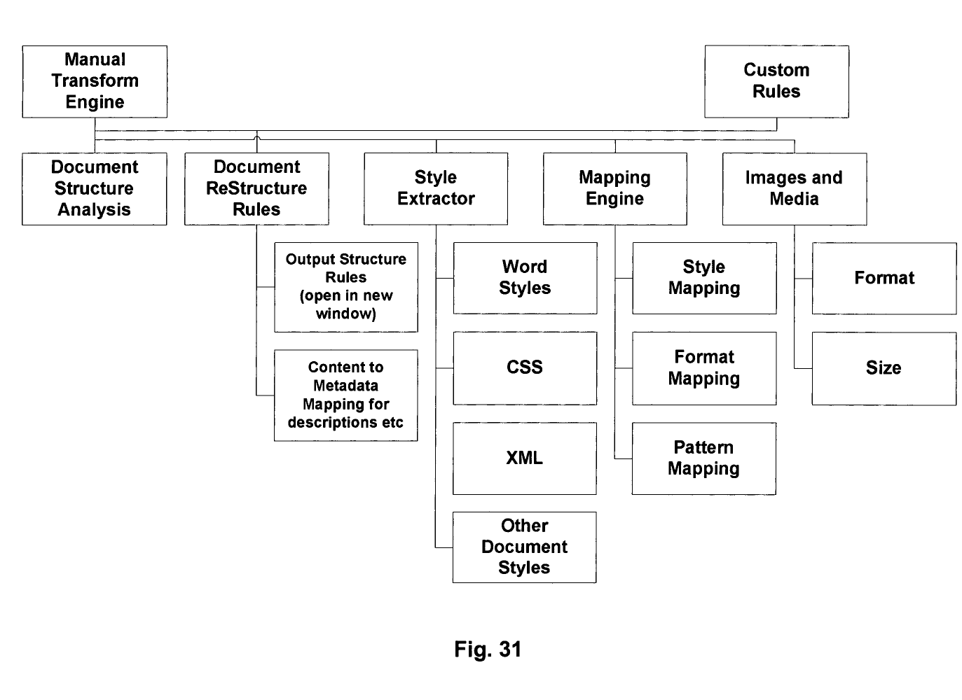

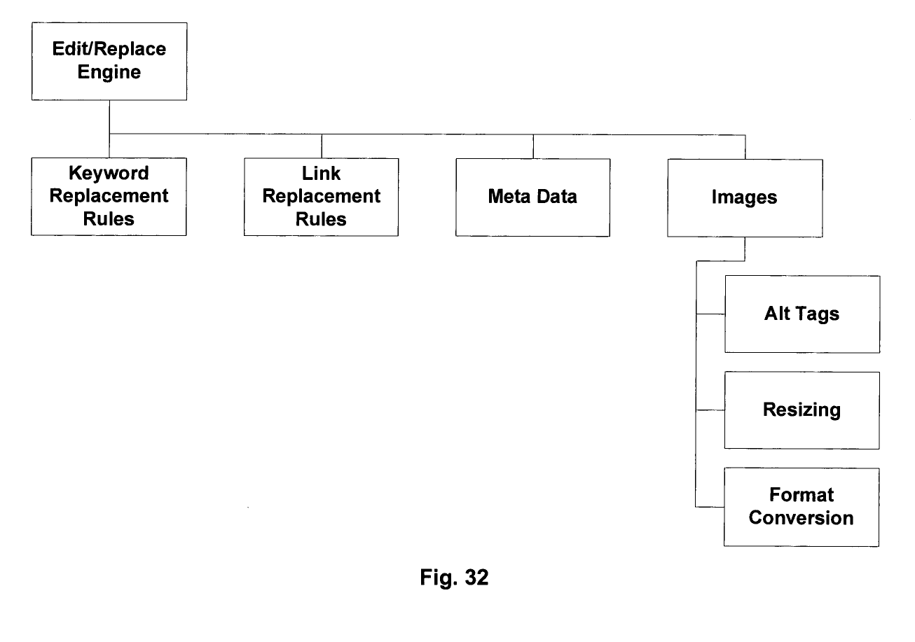

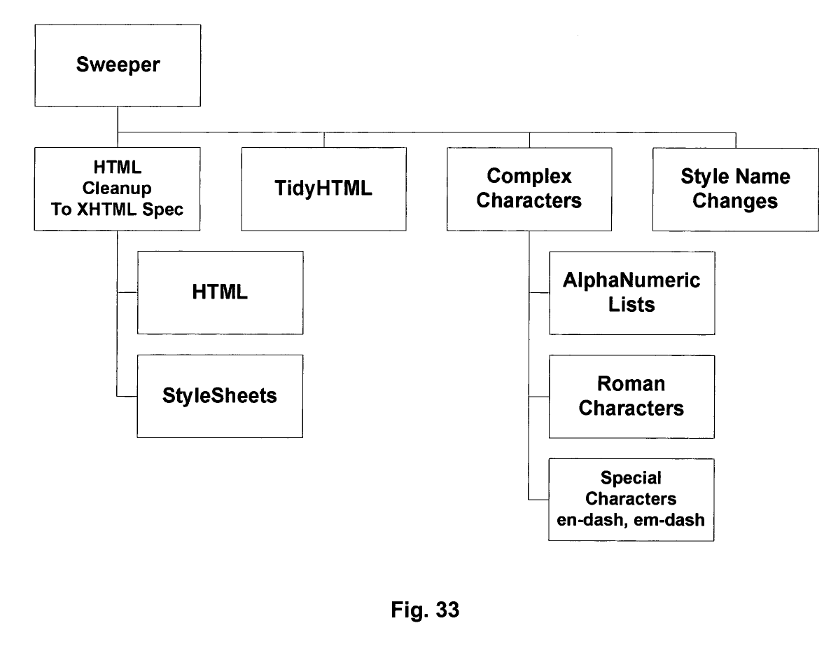

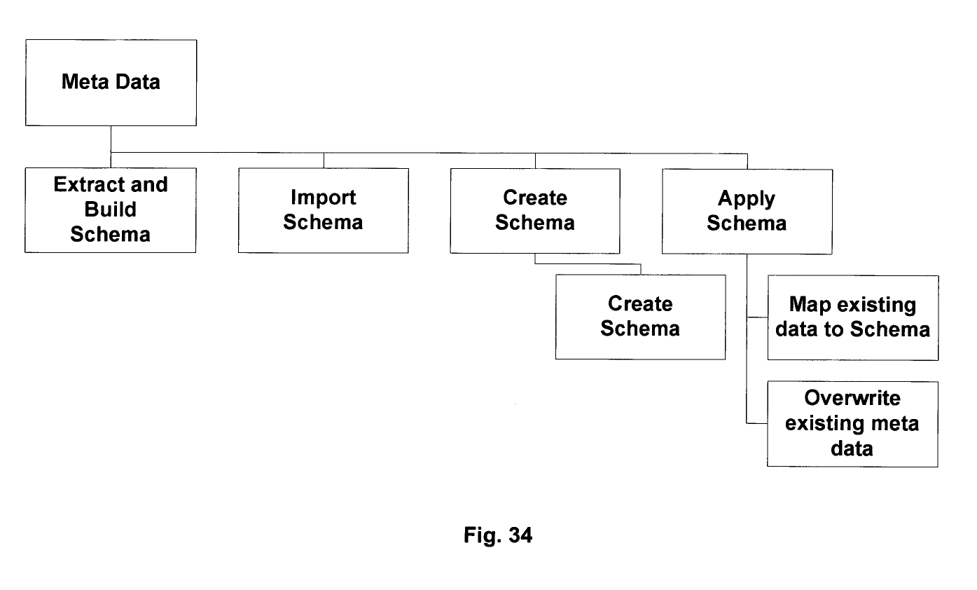

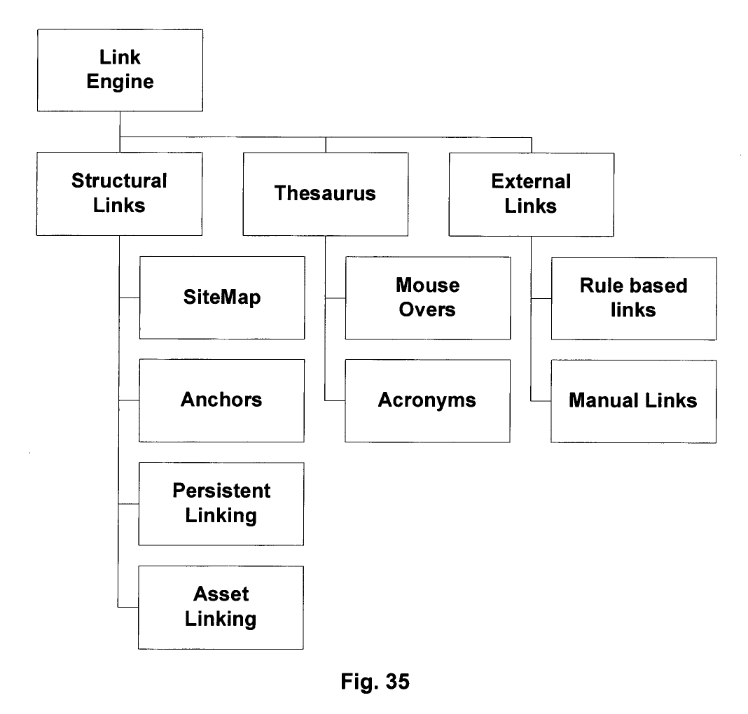

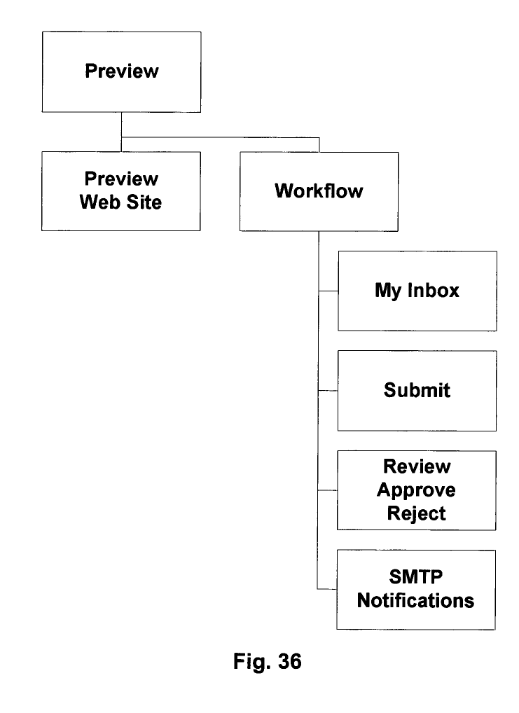

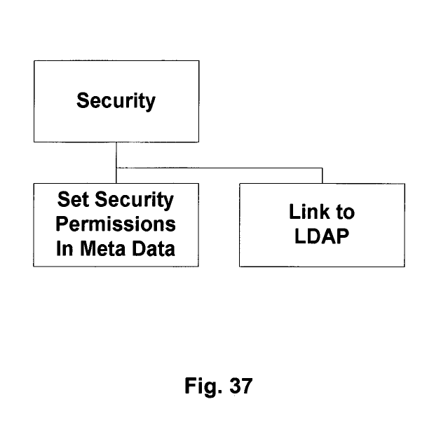

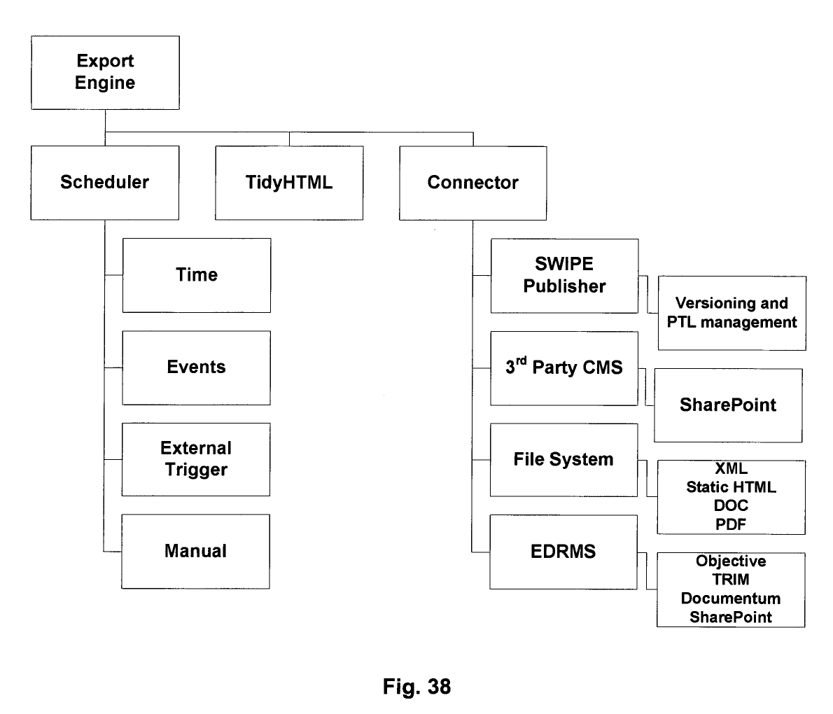

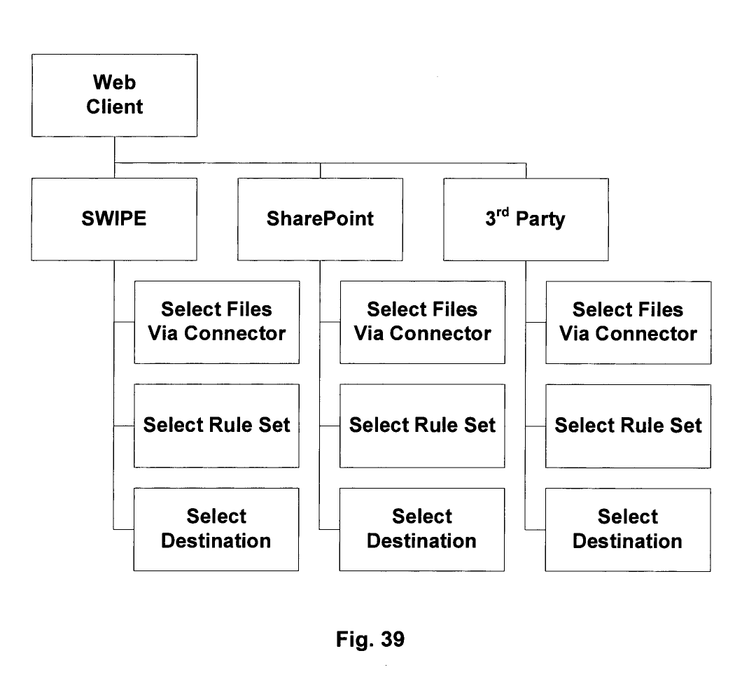

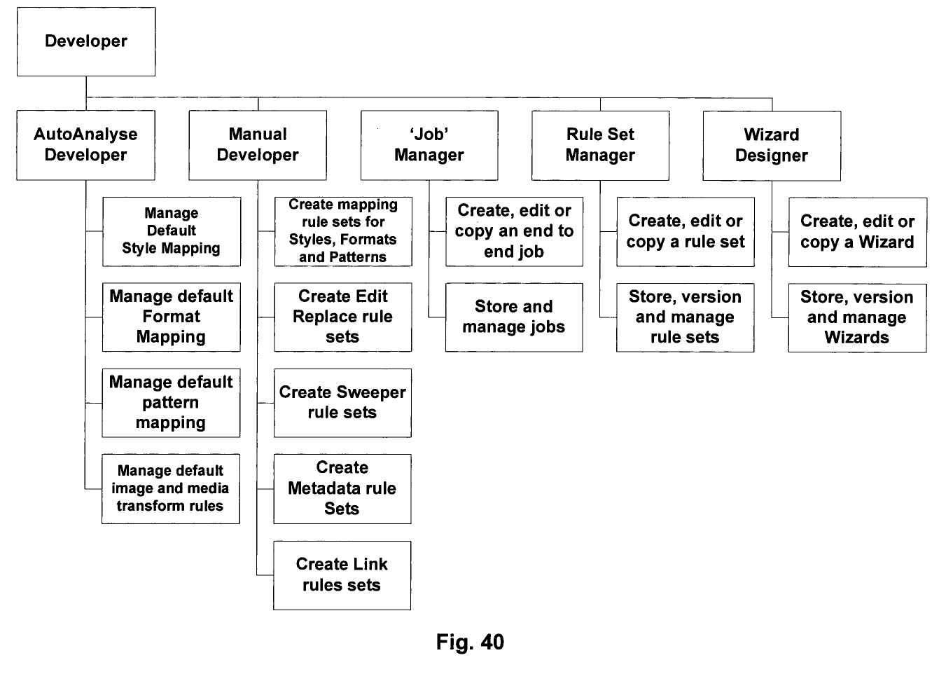

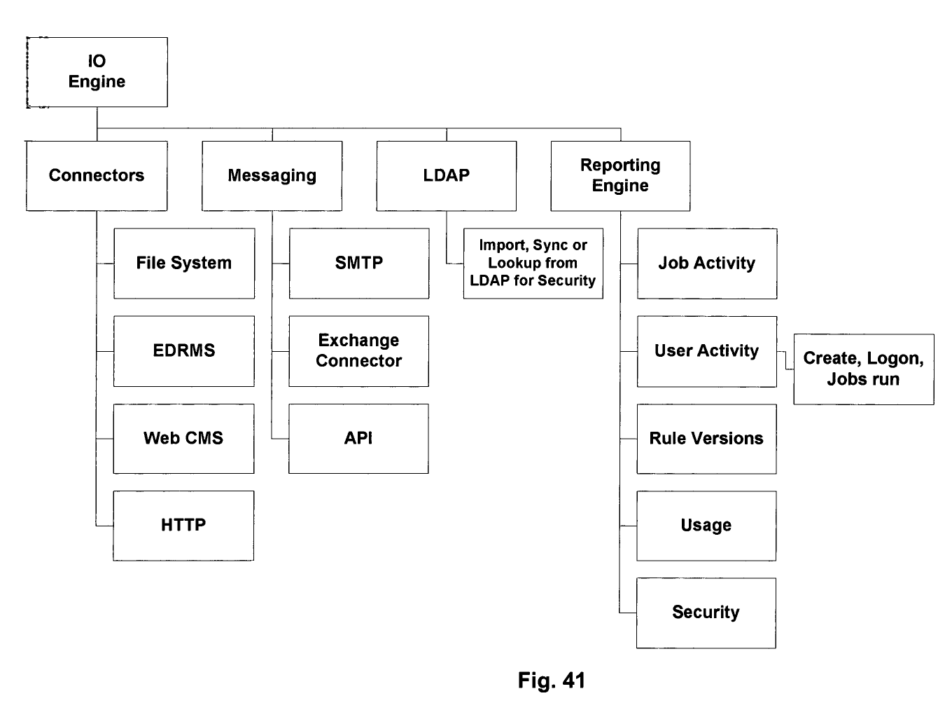

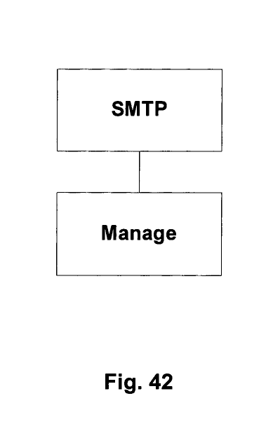

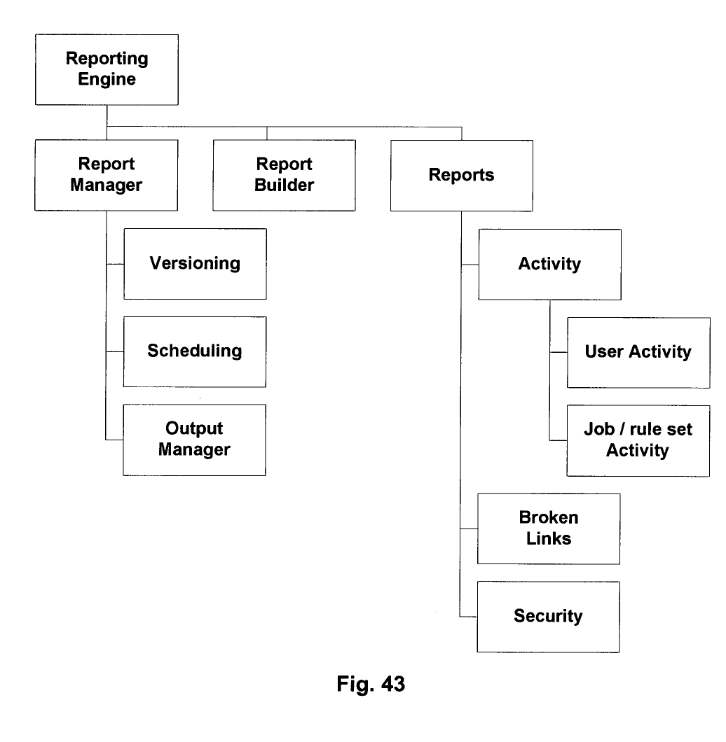

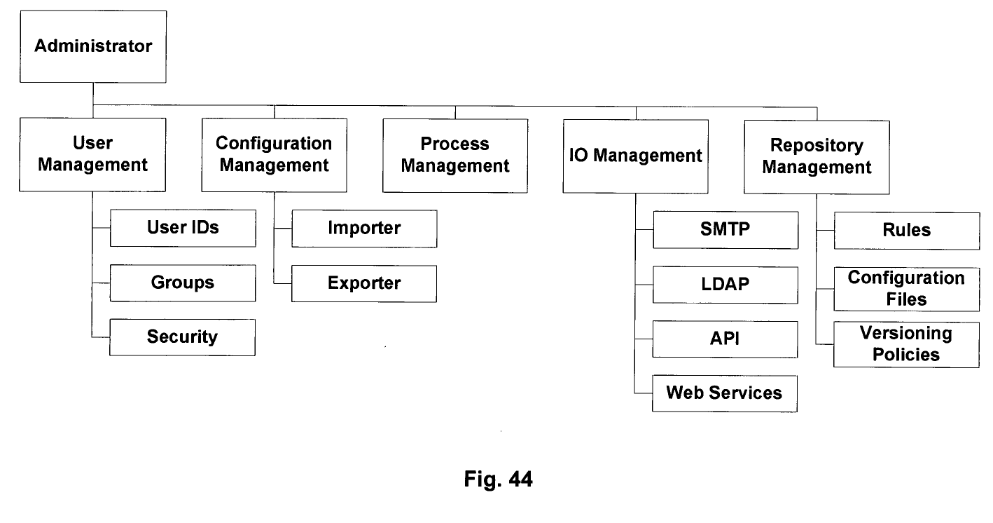

FIG. 27 to FIG. 44 depict various logical modules of the system.

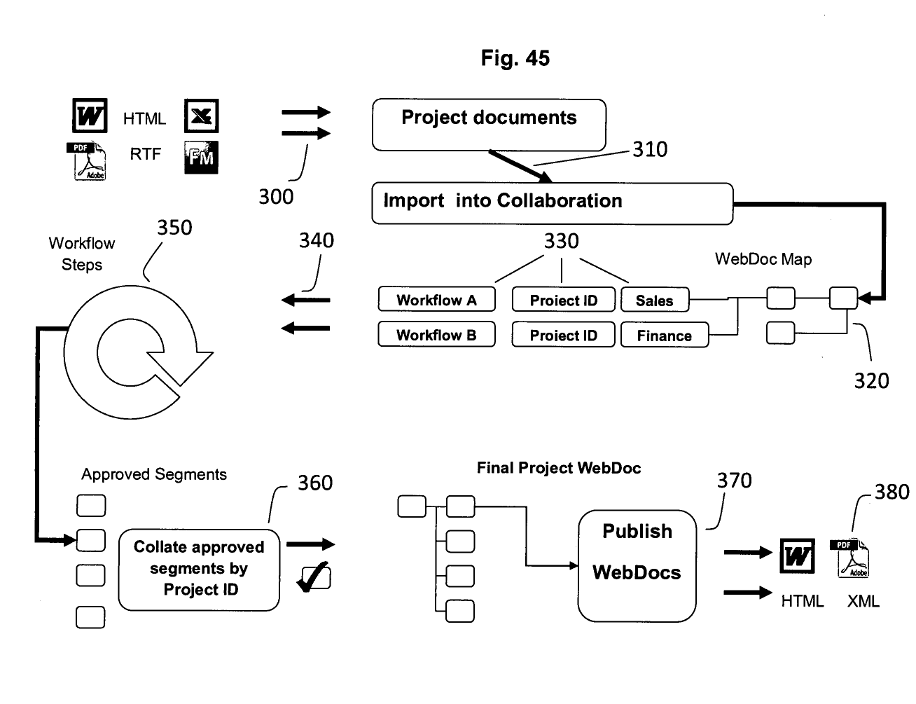

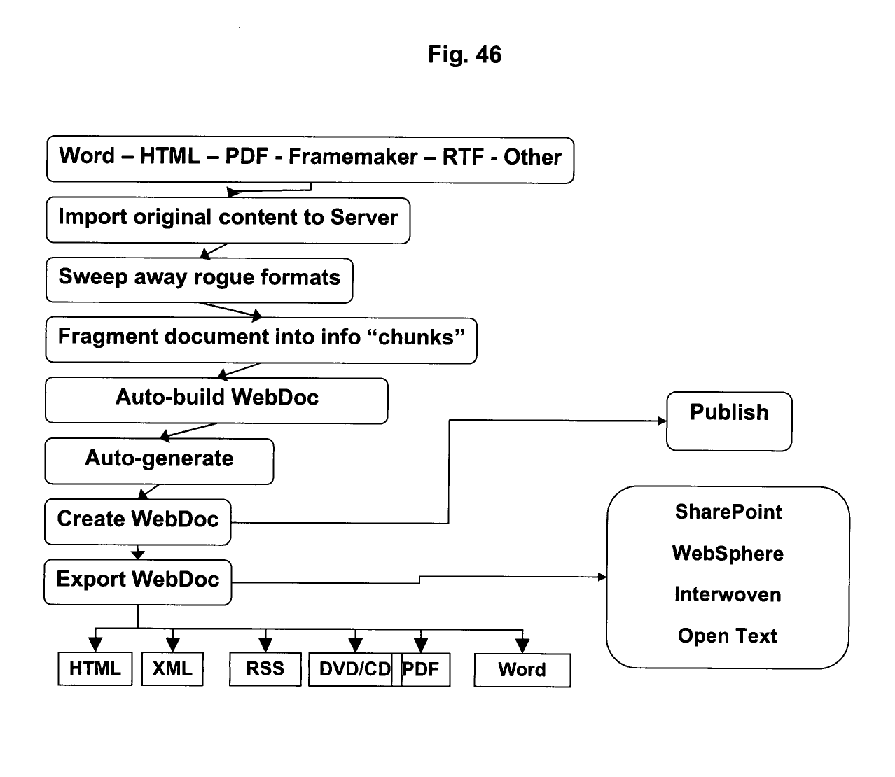

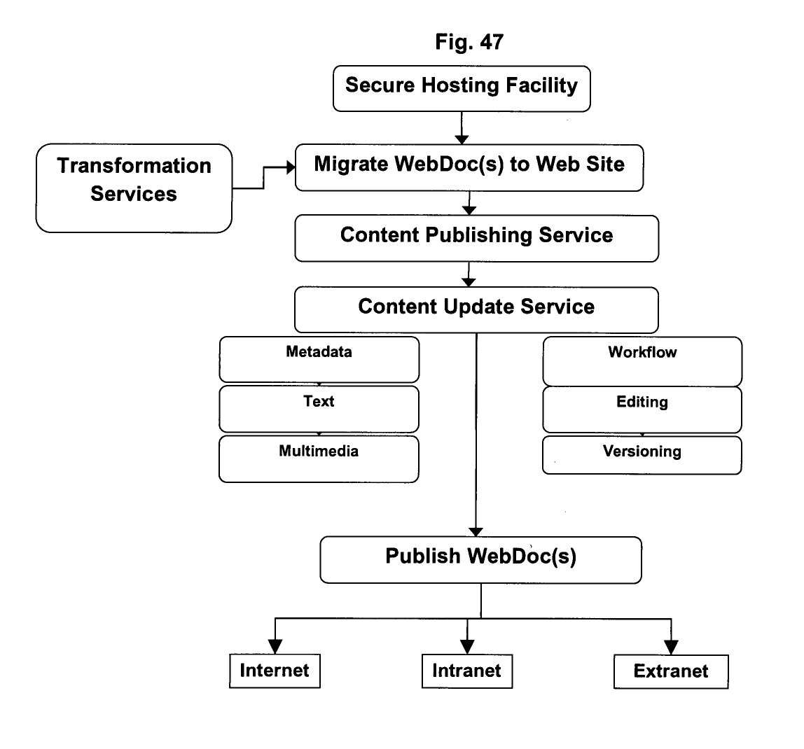

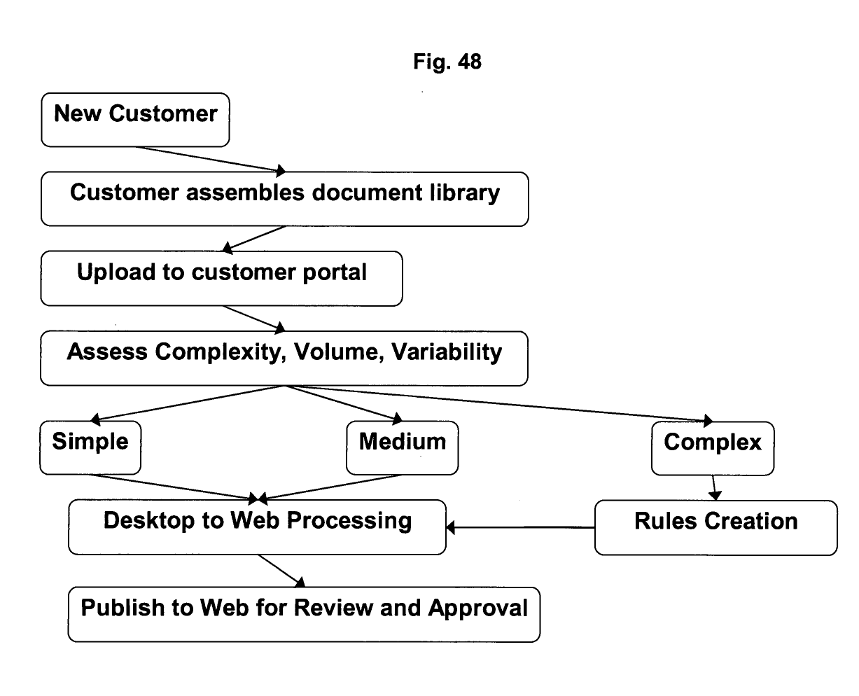

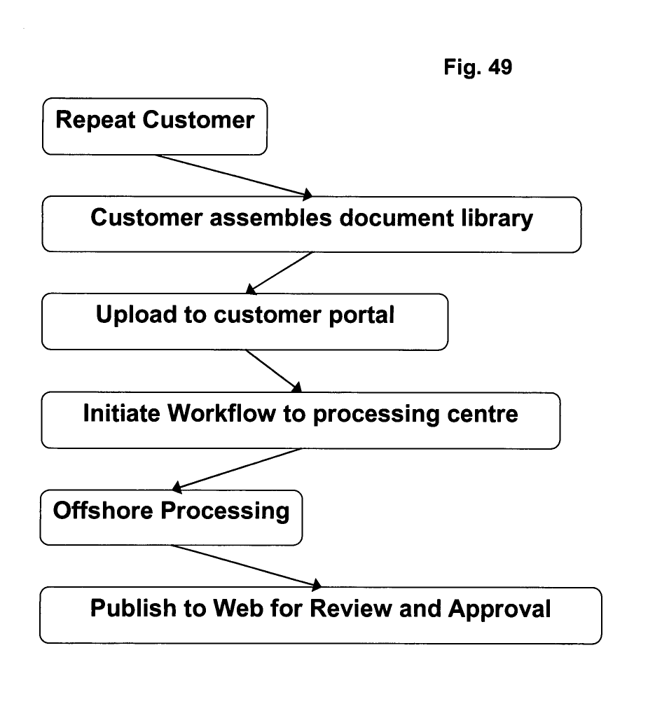

The system can be run as a standalone application on personal computer, or it can be run as a client/server application. FIG. 45 and FIG. 49 depict an entirely browser based delivery of the method described and depicted in FIGS. 1 and 1a. In most cases the system will be able to analyse the documents structure and determine whether further rules need to be developed in order to provide the segmentation and linking as would be needed to be applied to the documents. In the case of complex documents, the client of the web delivered service would be able to either (1) provide the clients of the service with the ability to author or apply rules to the documents through the web interface or (2) have a user of the system at vendor of the service's end author and apply the rules on behalf of the customer.

The system may or may not include a compatible structure agnostic CMS, as the users may not need to implement persistent external links over versions, or they may have their own CMS that may be capable of being integrated with.

According to a further aspect of the invention there is provided a collaboration tool for multiple authors to concurrently author, compare and version desktop documents.

A system is described as depicted in FIG. 45 which is adapted to host a collaboration tool. The system may be comprised of a local host for operation within a company's network and potentially by extension, VPN networks. Alternatively the system may be hosted on an internet server accessed through regular internet connections.

The system does not require any software on the hosts computer terminal and in fact it may be carried out in a browser. Alternatively the system may be provided through the use of a desktop app or indeed an application resident on a mobile internet device, PDA or smartphone.

In any case, whereas the other embodiments described herein do not specifically require a means of hosting or otherwise providing documents online (they could be published locally on a CD-ROM) the implementation provided herein for collaboration does require that the system be comprised of an additional communication module over and above the requirements for storage means, processing means and input means.

The method involved in facilitating this collaboration tool includes:
1. A shared on-line website is created with security for access to authorised users.
2. Importing 300 one or more desktop documents including desktop documents, web documents or structured database material.
3. Running 310 the rules based engine over the project documents in accordance with the method described in FIGS. 1 and 1a thereby segmenting the project documents into separate actual document with links to each other thereby creating a website 320 with many individual children pages that are tied back to the original project document. The document in this way into logical segments 330—eg. marketing, sales, financial, technical, each of which have their own team members to work on their section of the document. Alternatively the document may be split into other logical parts for consumption by a team of authors. There is no limit to the number of workflows or to the size of the project teams.
4. Each section will have its own workflow ID 340 but all will feature a common project ID.
5. Each workflow 330 will have associated with it an approval regime which encompasses providing certain authorised users with view, modification and/or rejection rights to the material within the workflow.
6. As an example in one workflow, each document involves a check in check out process which is incorporated in the workflow steps 350, once a document is checked out other people may review it but not modify it. Further a document when checked back in is able to be changed by the next person to check it out. In all cases, the prior versions are kept by reference to the unique identifier associated with each segment of the document in accordance with the method described in FIG. 1a.
7. The users of the system would then, in particular, those authorised to author and publish within their workflow 330 or alternatively those authorised to publish the overall project documents will then instruct the system to aggregate and collate all approved segments 360 through reference to the common projected which are then reconstituted into an updated project document.
8. The software then outputs the document 370 into any popular format 380 including XHTML, XML, Word, PDF, CD-Rom or indeed a compatible document management system.
9. All linking capabilities are used in collaboration.
10. All workflow participants can be alerted to any changes.

Various modifications may be made in details of design and construction without departing from the scope and ambit of the invention.

1. A method for dynamically publishing documents electronically, the method comprising the following steps:
Receiving at least one document;
Receiving at least one segmentation rule;
running the at least one segmentation rule over the at least one document;
displaying the potential segmentation points of the at least one document;
receiving input as to the acceptability of the potential segmentation points identified;
iteratively repeating the steps of receiving at least one segmentation rule and running over the at least one document and displaying the identified potential segmentation points until such time that the displayed identified potential segmentation points have been indicated to be acceptable by reference to received input;
segmenting the at least one document;
associating at least one unique identifier with each segment along with metadata that was used to identify and display the acceptable potential segmentations points;
receiving a linking rule;
running a linking rule to create potential link targets in the content of the segments;
displaying the potential links;
iteratively repeating the steps of running the at least one linking rule over each segment and reporting the collection of potential links until such time that the collection of potential links have been indicated to be acceptable by reference to received input;
resolving actual links from the list of generated potential links; and
publishing the segments electronically with actual links.

2. The method of claim 1 wherein the segmentation and linking rules are able to identify metadata in the at least one document's structure by reference to any one or more of the following:
formatting including levels of indentation and numbering;
available styles;
content;
predefined definitions;
hidden text;
embedded links; and
any other segment identifier.

3. The method of claim 2 wherein the step of segmenting the document involves first segmenting the document into logical segments, and wherein the document is not divided into separate documents or actual segments until after the at least one linking rule has been run over the at least one document to insert the potential links.

4. The method of claim 3 wherein the potential links are stored as mark up text, containing at least one unique identifier in the logical segments that comprises a link target.

5. The method of claim 4 wherein the step of resolving actual links from potential links involves correlating the at least one unique identifier contained in the markup associated with the potential link of an actual segment with the unique identifiers of the actual segments to be published and where there is correlation, creating an actual link between the actual segments.

6. The method of claim 5 wherein after the at least one document is received its structure is analysed and one or more suggested segmentation rules are suggested to the user before the user provides an indication as to which rule to run over the at least one document.

7. The method of claim 5 wherein the logical segments are associated with two unique identifiers.

8. The method of claim 7 wherein the two unique identifiers are the GUID and PageLinkRef.

9. The method of claim 7 wherein the actual segments are stored in a store by reference to their two unique identifiers.

10. The method of claim 9 wherein the contents of the store when published, are published as HTML files.

11. The method of claim 10 wherein the at least one unique identifier is associated with the filename and hence URL of the published HTML files.

12. The method of claim 9 wherein the contents of the store are published by a content management system.

13. The method of claim 12 wherein the content management system associates the address of the published document with at least one of the two unique identifiers.

14. The method of claim 13 wherein the wherein the at least one unique identifier is the GUID.

15. The method of claim 14 wherein the at least one document is further subjected to the application of one or more of the following prior to publication:
cleaning rules;
substitution rules;
accessibility and compliance rules.

16. The method of claim 13 wherein the following extra steps are conducted in order to publish amended versions of documents previously published in accordance with the method, the extra steps comprising:
receiving at least one amended document for republishing;
performing the segmentation and linking in order to create actual segmented and linked documents in accordance with the method;
correlating the previously segmented and published documents with the newly segmented documents and in the case where there is a correlation, assigning the at least one unique identifier of the previously published document to the newly created actual document that correlated with that previously published document, and in the case where no correlation with a previously published document can be found, assigning the uncorrelated document a new at least one unique identifier; and
publishing the documents, wherein the file names, address and/or location of each physical segment of the updated document remains unchanged from the address and/or location of the previously published document which it replaced.

17. A method for dynamically publishing documents electronically, the method comprising the following steps:
receiving at least one segmentation rule for identifying metadata in at least one document's structure by reference to one or more of the following:
i. formatting including levels of indentation and numbering
ii. available styles
iii. content
iv. predefined definitions
v. hidden text
vi. embedded links;
running the at least one segmentation rule over the at least one document to identify metadata for displaying potential segmentation points;
iteratively repeating the steps of receiving at least one segmentation rule and running over the at least one document and displaying the identified potential segmentation points until such time that the displayed identified potential segmentation points have been indicated to be acceptable by reference to received input;
segmenting the at least one document into logical segments;
associating at least one unique identifier along with the metadata that was used to display the acceptable potential segmentations points with their associated logical segment;
receiving at least one linking rule for identifying potential links between the logical segments identified by their at least one unique identifier wherein the linking rule identifies potential link targets in the content of logical segments using one or more of the following:
i. formatting including levels of indentation and numbering
ii. available styles
iii. content
iv. predefined definitions
v. hidden text
vi. embedded links;
running the at least one linking rule over each logical segment thereby creating a collection of potential links which comprise the at least one unique identifier of the target;
storing the at least one unique identifiers of the targets within the content of the logical segments displaying the marked up content of the logical segments;
iteratively repeating the steps of running the at least one linking rule over each logical segment and reporting the collection of potential links until such time that the collection of potential links have been indicated to be acceptable by reference to received input;
creating a store of actual segments to be published, wherein each actual segment corresponds to a logical segment and is marked up with the potential link targets to other documents in the store and wherein each actual segment is referenced in the store by its at least one unique identifier and metadata;
creating actual links from the potential links by comparing the at least one unique identifier contained in the markup associated with the potential link with at least one unique identifier of the actual segment to be published; and
publishing the contents of the store.

18. The method of claim 17 wherein the logical segments are associated with a GUID as the unique identifier.

19-23. (canceled)

24. A method for comparing and versioning documents already published such that the updated published documents can maintain the links to and from them such that third parties can rely on existing links that will not break (persistent linking) the method comprising the following steps:
receiving at least one segmentation rule for identifying metadata in at least one document's structure by reference to any one or more of the following:
i. formatting including levels of indentation and numbering
ii. available styles
iii. content
iv. predefined definitions
v. hidden text
vi. embedded links;
running the at least one segmentation rule over the at least one document to identify the metadata;
displaying potential segmentation points based on the metadata identified by the running of the at least one segmentation rule;
iteratively repeating the steps of receiving at least one segmentation rule and running over the at least one document and displaying the identified potential segmentation points until such time that the displayed identified potential segmentation points have been indicated to be acceptable by reference to received input;
segmenting the at least one document into logical segments associating at least one unique identifier along with the metadata that was used to display the acceptable potential segmentations points with their associated logical segment;
defining at least one linking rule for identifying potential links between the logical segments identified by their at least one unique identifiers wherein the linking rule identifies potential link targets in the content of logical segments using any one or more of the following:
i. formatting including levels of indentation and numbering
ii. available styles
iii. content
iv. predefined definitions
v. hidden text
vi. embedded finks;
running the at least one linking rule over each logical segment thereby creating a collection of potential links which comprise at least the at least one unique identifier of the target;
storing the unique identifiers of the targets within the content of the logical segments displaying the marked up content of the logical segments;
iteratively repeating the steps of running the at least one linking rule over each logical segment and reporting the collection of potential links until such time that the collection of potential links have been indicated to be acceptable by reference to received input;
creating a store of actual segments to be published, wherein each actual segment corresponds to a logical segment and is marked up with the potential link targets to other documents in the store and wherein each actual segment is referenced in the store by its at least one unique identifier and metadata;
creating actual links from the potential links by comparing the at least one unique identifier contained in the markup associated with the potential link with at least one unique identifier of the actual segment to be published;
publishing the contents of the store;
taking at least one modified version of the at least one source document previously published and applying segmentation and linking rules to them;
correlating the newly segmented actual segments with the existing actual segments contained in the store;
assigning the correlated segments the unique identifier of the previously published segments, and where no correlation can be made, assigning new unique identifiers to those segments;
storing the segments using the unique identifiers; and
publishing the contents of the store, wherein the address and/or location of each updated document segment referred to by each entry in the store is references by the unique identifier of the segment.

25. The method of claim 24 wherein the contents of the store can be published as static HTML files and wherein the at least one unique identifier is included in the HTML files filename.

26-39. (canceled)
